(19) United States
(12) Patent Application Publication
(10) Pub. No.: US 2026/0288382 A1
(43) Pub. Date: Sep. 24, 2026

(54) PRINTING APPARATUS AND NON-TRANSITORY MEDIUM STORING PROGRAM FOR PRINTING APPARATUS

(71) Applicant: BROTHER KOGYO KABUSHIKI KAISHA, Nagoya (JP)

(72) Inventors: Yuichiro SUZUKI, Komaki (JP); Tomoyasu FUKUI, Inuyama (JP); Yoshitsugu TOMOMATSU, Nagoya (JP); Yosuke OHASHI, Nisshin (JP); Keisuke NISHIHARA, Nagoya (JP)

(21) Appl. No.: 19/461,469

(22) Filed: Jan. 27, 2026

(30) Foreign Application Priority Data
Jan. 31, 2025 (JP) 2025-015408

(51) Int. Cl. G06F 3/12

(52) U.S. Cl. CPC G06F 3/1204; G06F 3/121; G06F 3/1254; G06F 3/1257; G06F 3/1261; G06F 3/1288

(57) ABSTRACT

A printing apparatus includes: a memory, a printing mechanism, a communication interface, and a processor. The memory stores a template database including one or more records each including a template ID and template data. In a case where the processor obtains a print instruction including the template ID and related information related to print content data, the processor causes the printing mechanism to perform printing of a print image in which a print content is applied to a layout indicated by the template data associated with the template ID. In a case where the printing of the print image is not completed and where another printing apparatus is connected to the printing apparatus, the processor transmits, to the another printing apparatus, first data including the print content data and the template data, or second data indicating the print image based on the print content data and the template data.

### REFERENCE TO RELATED APPLICATIONS

This application claims priority from Japanese Patent Application No. 2025-015408 filed on Jan 31, 2025. The entire content of the priority application is incorporated herein by reference.

### BACKGROUND ART

A known label printer receives a print instruction including additional image information on an additional image, and template identifying information from an external apparatus. In a case where a background image associated with the template identifying information is stored in a background image memory, the label printer performs a printing process of printing, on a label, a label image obtained by synthesizing the additional image and the background image. On the other hand, in a case where the background image associated with the template identifying information is not stored in the background image memory, the label printer does not perform the printing process.

### SUMMARY

In a case where an error occurs in a printing apparatus during the printing based on the print instruction, a user desires to continue the printing based on the print instruction in a substitute printing apparatus, in some cases. The substitute printing apparatus might not store a template used by the printing apparatus in which the error has occurred. In the known label printer or printing apparatus, however, an appropriate process to be performed in a case where the template is not stored in the substitute printing apparatus has not been proposed.

An object of the present disclosure is to provide a printing apparatus, and a non-transitory medium storing a program for the printing apparatus, each capable of performing an appropriate process in a case where another printing apparatus is used as a substitute for a printing apparatus, and where a template is not stored in the another printing apparatus.

A printing apparatus according to a first aspect of the present disclosure includes: a first memory, a printing mechanism, a communication interface, and a processor. The first memory stores a template database including one or more records, each of the one or more records including a template ID and template data. The template data is used to print a predetermined print content based on a predetermined layout. The template ID is associated with the template data.

The processor is configured to perform an obtaining process, a first printing process, and a first transmitting process. The obtaining process is a process of obtaining a print instruction including related information related to print content data which indicates the print content, and the template ID. The first printing process is a process of causing the printing mechanism to perform printing of a print image. The print image is an image in which the print content, identified based on the related information, is applied to the layout indicated by the template data associated with the template ID. The first printing process is performed in a case where the processor obtains the print instruction in the obtaining process.

The first transmitting process is a process of transmitting first data or second data to another printing apparatus via the communication interface. The first data is data including the print content data related to the related information and the template data associated with the template ID. The second data is data indicating the print image based on the print content data and the template data. The first transmitting process is performed in a case where the printing by the first printing process is not completed, and where the another printing apparatus is connected to the printing apparatus.

The printing apparatus according to the first aspect generates the first data including the print content data related to the related information and the template data associated with the template ID, and transmits the first data to the another printing apparatus. Alternatively, the printing apparatus transmits the second data indicating the print image based on the print content data and the template data to the another printing apparatus. Thus, even in a case where the another printing apparatus does not possess the template data, the printing apparatus contributes to causing the another printing apparatus to print, on a print medium, the appropriate print image based on the first data or the second data.

A printing apparatus according to a second aspect of the present disclosure is configured to substitute for another printing apparatus so as to perform printing in a case where printing by the another printing apparatus is not completed. The printing apparatus includes: a communication interface, a printing mechanism, and a processor.

The processor is configured to perform a first receiving process and a second printing process. The first receiving process is a process of receiving first data or second data from the another printing apparatus via the communication interface. The first data is data including print content data and template data. The print content data is data indicating a predetermined print content. The template data is data used to print the print content based on a predetermined layout.

The second data is data indicating a print image in which the print content is applied to the layout. The second printing process is a process of causing the printing mechanism to perform printing based on the first data or the second data. The second printing process is performed in a case where the processor receives the first data or the second data in the first receiving process.

The printing apparatus according to the second aspect receives either the first data or the second data from the another printing apparatus. In a case where the printing apparatus receives the first data, the printing apparatus is capable of generating the print image based on the print content data and the template data. In a case where the printing apparatus receives the second data, the printing apparatus is capable of obtaining the print image generated by the another printing apparatus. The printing apparatus is capable of causing the printing mechanism to print the print image. Therefore, even in a case where the printing apparatus does not possess the template data, the printing apparatus is capable of printing, on a print medium, an appropriate print image based on the first data or the second data, as a substitute for the another printing apparatus.

A printing apparatus according to a third aspect of the present disclosure is configured to substitute for another printing apparatus so as to perform printing in a case where printing by the another printing apparatus is not completed. The printing apparatus includes: a communication interface, a printing mechanism, and a processor.

The processor is configured to perform a second receiving process, a third receiving process, and a third printing process. The second receiving process is a process of receiving access information to a content server, from the another printing apparatus via the communication interface.

The third receiving process is a process of receiving first data or second data from the content server and using the access information. The first data includes related information and template data. The related information is related to print content data indicating a predetermined print content. The template data is data used to print the print content based on a predetermined layout.

The second data is data indicating a print image in which the print content is applied to the layout. The third printing process is a process of causing the printing mechanism to perform printing based on the first data or the second data. The third printing process is performed in a case where the processor receives the first data or the second data in the third receiving process.

The printing apparatus according to the third aspect receives either the first data or the second data from the content server. In a case where the printing apparatus receives the first data, the printing apparatus is capable of generating a print image based on the print content data and the template data. In a case where the printing apparatus receives the second data, the printing apparatus is capable of obtaining the print image generated by the another printing apparatus. The printing apparatus is capable of causing the printing mechanism to perform printing of the print image. Therefore, even in a case where the printing apparatus does not possess the template data, the printing apparatus is capable of printing an appropriate print image based on the first data or the second data, as a substitute for the another printing apparatus.

According to a fourth aspect of the present disclosure, a non-transitory medium storing a program for a printing apparatus is provided. The program causes a processor of a printing apparatus to perform a process, the printing apparatus being configured to perform printing on a print medium.

The printing apparatus includes: a first memory, a printing mechanism, a communication interface, and the processor. The first memory stores a template database including one or more records, each of the one or more records including a template ID and template data. The template data is used to print a predetermined print content based on a predetermined layout. The template ID is associated with the template data.

The program for the printing apparatus causes the processor of the printing apparatus to perform: an obtaining process, a first printing process, and a first transmitting process. The obtaining process is a process of obtaining a print instruction including related information related to print content data, which indicates the print content, and the template ID. The first printing process is a process of causing the printing mechanism to perform printing of a print image. The print image is an image in which the print content, identified based on the related information, is applied to the layout indicated by the template data associated with the template ID. The first printing process is performed in a case where the processor obtains the print instruction in the obtaining process.

The first transmitting process is a process of transmitting first data or second data to the another printing apparatus via the communication interface. The first data is data including the print content data related to the related information and the template data associated with the template ID. The second data is data indicating the print image based on the print content data and the template data. The first transmitting process is performed in a case where the printing by the first printing process is not completed, and where the another printing apparatus is connected to the printing apparatus. Therefore, the fourth aspect achieves the effect similar to the effect achieved by the first aspect.

The present disclosure may optionally combine any of the specific features as defined in claims 1 to 20.

### BRIEF DESCRIPTION OF DRAWINGS

FIG. 1 is a diagram illustrating the configuration of a print substitution system.

FIG. 2A is a diagram schematically illustrating a predefined text DB and FIG. 2B is a diagram schematically illustrating a template DB.

FIGS. 3A to 3C are diagrams schematically illustrating cases where substitute printing are performed by the print substitution system.

FIG. 4 is a sequence diagram (1/9) of a process performed by the print substitution system.

FIG. 5 is a sequence diagram (2/9) of the process performed by the print substitution system.

FIGS. 6A and 6B are a sequence diagram (3/9) of the process performed by the print substitution system.

FIG. 7 is a sequence diagram (4/9) of the process performed by the print substitution system.

FIG. 8 is a sequence diagram (5/9) of the process performed by the print substitution system.

FIG. 9 is a sequence diagram (6/9) of the process performed by the print substitution system.

FIG. 10 is a sequence diagram (7/9) of the process performed by the print substitution system.

FIGS. 11A and 11B are a sequence diagram (8/9) of the process performed by the print substitution system.

FIG. 12 is a sequence diagram (9/9) of the process performed by the print substitution system.

FIGS. 13A and 13B are diagrams schematically illustrating a case where the substitute printing is performed by a print substitution system.

FIGS. 14A and 14B are a sequence diagram (1/7) of a process performed by the print substitution system.

FIG. 15 is a sequence diagram (2/7) of the process performed by the print substitution system.

FIG. 16 is a sequence diagram (3/7) of the process performed by the print substitution system.

FIGS. 17A and 17B are a sequence diagram (4/7) of the process performed by the print substitution system.

FIG. 18 is a sequence diagram (5/7) of the process performed by the print substituting system.

FIGS. 19A and 19B are a sequence diagram (6/7) of the process performed by the print substitution system.

FIG. 20 is a sequence diagram (7/7) of the process performed by the print substitution system.

### DESCRIPTION

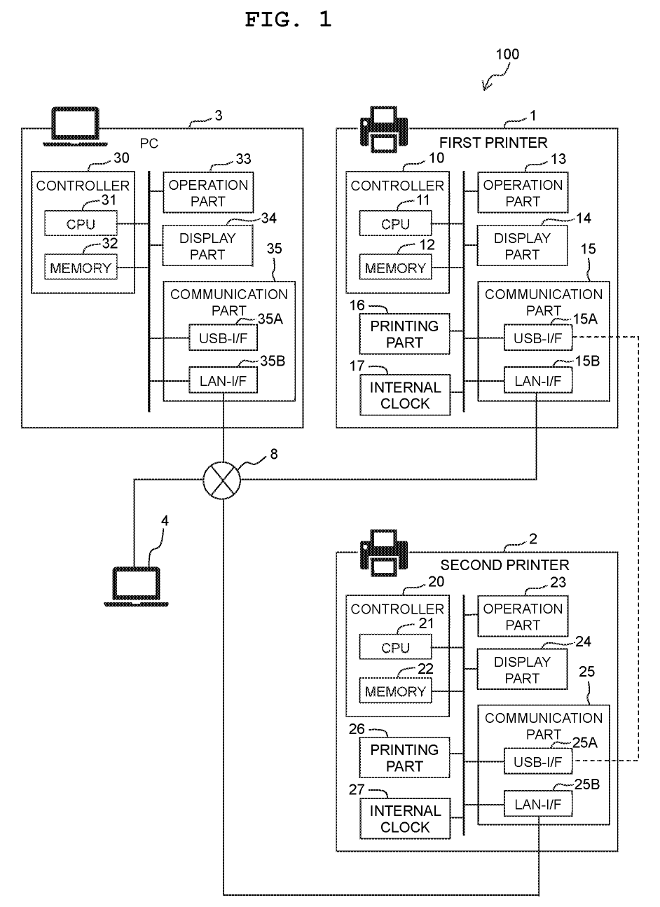

The first embodiment of the present disclosure will be described, with reference to the drawings. The configuration of a print substitution system 100 will be described, with reference to FIG. 1. The drawings referred to are used to describe the technical features which the present disclosure may adopt. The configuration, etc., of the apparatus described herein is not intended to limit the present disclosure in any way, but is merely a descriptive example of the present disclosure.

The print substitution system 100 is a system which connects a second printer 2 to a first printer 1 in a case where the first printer 1 is in a state where printing by the first printer 1 is not completed, and uses the second printer 2 for printing. As illustrated in FIG. 1, the print substitution system 100 includes a PC 3, the first printer 1, the second printer 2, and a server 4. Note that the term "PC" is an abbreviation for "personal computer". The PC 3 is an apparatus which is, for example, operated by a user, and which outputs a print instruction to the first printer 1. The first printer 1 and the second printer 2 may be of the same model and may have the same functions. Alternatively, the first printer 1 and the second printer 2 may be of different models and may have different functions.

The PC 3 includes a controller 30, an operation part 33, a display part 34, and a communication part 35. The controller 30 includes a CPU 31 and a memory 32. The CPU 31 controls the overall operation of the PC 3.

The memory 32 is, for example, a volatile memory, a non-volatile memory, etc. The memory 32 stores at least an OS, a print application program, and various data. In the following description, the application program is also referred to simply as an "application". The OS is a program which controls the basic operation of the PC 3. The print application is a program which generates the print instruction to cause the first printer 1 to perform printing.

The operation part 33 is an input device configured to input various information into the PC 3. The operation part 33 includes, for example, a mouse, a keyboard, etc. The display part 34 is a display configured to display the various information.

The communication part 35 includes a USB I/F 35A and a LAN I/F 35B. Note that the term "I/F" is an abbreviation for "interface". The USB I/F 35A is a connection interfaceconfigured to connect computer peripherals to the PC 3 via USB. The computer peripherals are various devices connected to and used with a computer. The USB I/F 35A supports the USB printer class.

The LAN-I/F 35B is a connection interface configured to connect to a network 8 and to perform communication between terminals or with the computer peripherals. The network 8 may be a LAN, the Internet, or a dedicated line, or may be a configuration including two or more of the LAN, the Internet, and the dedicated line. The PC 3 may be directly connected to and may communicate with the computer peripherals using the LAN-I/F 35B.

The first printer 1 is a computer peripheral having a print function. The first printer 1 according to the first embodiment is a label printer which performs printing on labels. The first printer 1 may also be a roll printer which performs printing on a roll sheet, or a page printer which performs printing on cut sheets. Further, the first printer 1 may be a multifunction peripheral having, for example, a scan function, a FAX function, etc., in addition to the print function.

The first printer 1 includes a controller 10, an operation part 13, a display part 14, a communication part 15, a printing part 16, and an internal clock 17. The controller 10 includes a CPU 11 and a memory 12. The CPU 11 controls the overall operation of the first printer 1.

The memory 12 is, for example, a volatile memory, a non-volatile memory, etc. The memory 12 stores at least a control application, a substitute application, a predefined text DB, and a template DB. Note that the term "DB" is an abbreviation for "database". The control application is a program for controlling the basic operation of the first printer 1. The control application is executed when the first printer 1 starts up. The substitute application of the first printer 1 is a program which performs various processes to cause the second printer 2 to perform the printing, instead of the first printer 1.

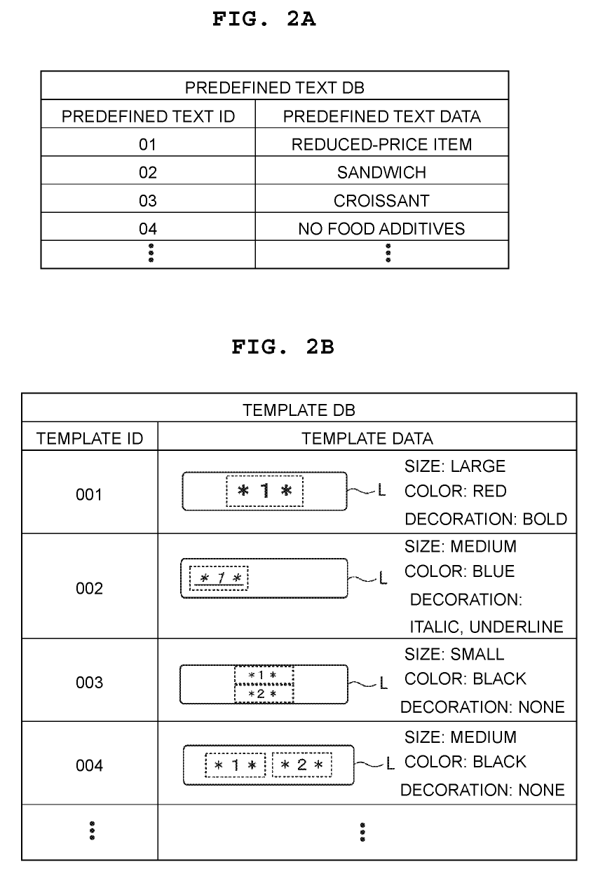

FIG. 2A illustrates an example of the predefined text DB. The predefined text DB is a database including a plurality of records. Each of the records includes predefined text data and a predefined text ID. The predefined text data indicates a predefined text generated in advance to be printed on a label, and is associated with the predefined text ID which is ID for identifying the predefined text data. In the example illustrated in FIG. 2A, the predefined texts are represented, for example, by texts such as "sandwich", "croissant", etc. For example, a predefined text indicated by predefined text data associated with a predefined text ID "01" is "reduced-price item".

FIG. 2B illustrates an example of the template DB. The template DB is a database including a plurality of records. Each of the records includes template data and a template ID. The template data indicates, for example, a template in which the predetermined text or input text is disposed, and is associated with the template ID which is an ID for identifying the template data. FIG. 2B illustrates, in a template data field, an example of the template data. In a print area, in a label L, of the template data, a dotted frame indicates a position in which a predefined text or an input text is disposed. In FIG. 2B, a dotted frame displayed as "*1*" indicates a position in which a first predefined text or a first input text is disposed. In a case where a plurality of predefined texts or input texts exist, e.g., two predefined texts or two input texts exist, the first predefined text or input text of the two predefined texts or input texts is disposed in the dotted frame displayed as "*1*, and the second predefined text or input text is disposed in a dotted frame displayed as "*2*". Further, with respect to each of the plurality of predefined texts or input texts, the text size is preset as large, medium, or small, and text color, text decoration, etc., are also preset. The size of the dotted frame is appropriately adjusted in accordance with, for example, the number of characters, the text size, etc.

For example, template data associated with a template ID "001" includes a layout in which one predefined text or input text is disposed in a dotted frame displayed as "*1*" in the center of the label L. For example, in a case where the predefined text ID "01" and the template ID "001" are designated, the text " reduced-price item" in red letters decorated in large-sized and bold font is printed in the center of the label L.

Template data associated with a template ID "003" includes a layout in which two predefined texts or input texts are disposed in two rows at the center of the label L. For example, in a case where predefined text IDs "02" and "04" and a template ID "003" are designated, a first predefined text is disposed in an upper dotted frame displayed as "*1*", and a second predefined text is disposed within a lower dotted frame displayed as "*2*". That is, a label L in which a text "sandwich" and a text "No food additives" in small and black font are disposed in the two rows is printed.

The operation part 13 includes a plurality of keys. By operating the operation part 13, the user is capable of inputting various instructions into the first printer 1. The display part 14 is a display configured to indicate various information.

The communication part 15 includes a USB-I/F 15A and a LAN-I/F 15B. The USB-I/F 15A is a connection interface configured to establish a USB connection with the computer equipment including the PC 3, and with the computer peripherals including the second printer 2. The USB-I/F 15A supports network connection via the Ethernet over USB protocol. The LAN-I/F 15B is a connection interface configured to connect to the network 8 and to communicate with the computer equipment including the PC 3. The USB-I/F 15A supports the USB printer class.

The printing part 16 is a printing mechanism configured to perform printing on labels. In a template print mode, the printing part 16 prints, on a label, a print image in which a template is applied to a predefined text or input text. The internal clock 17 is a clock built into the first printer 1 and is powered by a battery.

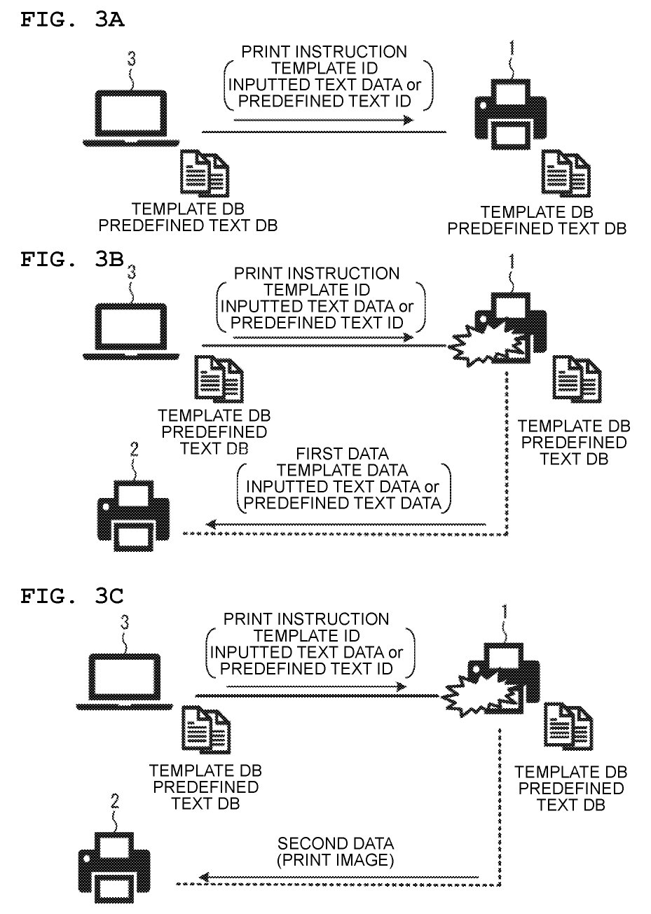

The template print mode is a print mode wherein a process of synthesizing a print image in which a template is applied to a predefined text or input text and of printing the print image on a label in the first printer 1 is performed. As illustrated in FIG. 3A, the template DB and the predefined text DB are stored in advance in the memory 32 of the PC 3 and the memory 12 of the first printer 1.

In the template print mode, the PC 3 prepares input text data, or a predefined text ID associated with a predefined text designated by the user, and a template ID corresponding to a template designated by the user. The input text data is data of the text input by the user. The PC 3 generates a print instruction including the template ID, the input text data or the predefined text ID, and information necessary for printing, and transmits the print instruction to the first printer 1. The information necessary for the printing includes, for example, print position in accordance with the label width, margin setting, magnification, the number of copies, and the other information. In the template print mode, the print instruction received by the first printer 1 may be configured not to include the template data, or image data based on the template data and print content data.

In a case where the print instruction includes the predefined text ID, the first printer 1 extracts predefined text data, associated with the predefined text ID, from the predefined text DB. The first printer 1 extracts templatedata, associated with the template ID included in the print instruction, from the template DB. The first printer 1 synthesizes a print image in which the template indicated by the template data is applied to either the input text indicated by the input text data or the predefined text indicated by the predefined text data. The print image is raster data composed of pixels. The first printer 1 prints the print image on the label based on the information necessary for printing.

Note that the first printer 1 has, for example, a normal print mode as another print mode different from the template print mode. In the normal print mode, the first printer 1 prints a print image synthesized in the PC 3 on the label. In the normal print mode, the PC 3 prints the input text input by the user, or the predefined text designated by the user, on the label using the layout set by the user, rather than using the template data stored in the memory 12 of the first printer 1. The PC 3 generates a print instruction including a print image indicating the input text or the predefined text, either in the layout designated by the user or in the layout applied based on the template data stored in the PC 3, together with the information necessary for printing the print image, and the PC 3 transmits the print instruction to the first printer 1. The first printer 1 prints the print image on the label based on the print instruction. In the normal print mode, the print instruction received by the first printer 1 may include the template data, or image data based on both the template data and the print content data.

The second printer 2 is a computer peripheral having the print function. The second printer 2 in the first embodiment is, for example, a printer of the same series as the first printer 1. The first printer 1 and the second printer 2 may be printers of the same series or of different series.

The second printer 2 includes a controller 20, an operation part 23, a display part 24, a communication part 25, a printing part 26, and an internal clock 27. The controller 20 includes a CPU 21 and a memory 22. The CPU 21 controls the overall operation of the second printer 2.

The memory 22 is, for example, a volatile memory, a non-volatile memory, etc. The memory 22 stores at least a control application and a substitute application. The control application is executed when the second printer 2 starts up. The substitute application of the second printer 2 is a program which performs various processes to cause the second printer 2 to perform printing, instead of the first printer 1.

The operation part 23 includes a plurality of keys. By operating the operation part 23, the user is capable of inputting various instructions into the second printer 2. The display part 24 is a display configured to indicate various information.

The communication part 25 includes a USB-I/F 25A and a LAN-I/F 25B. The USB-I/F 25A is a connection interface for establishing the USB connection with the computer equipment including the PC 3, and with the computer peripherals including the first printer 1. Note that the USB-I/F 25A supports network connection via the Ethernet over USB protocol. In a case wherethe second printer 2 performs the substitute printing for the first printer 1, the first printer 1 is connected to the USB-I/F 25A via USB. Similarly, in a case wherea third printer performs the substitute printing for the second printer 2, the third printer is connected to the USB-I/F 25A via USB. The LAN-I/F 25B is a connection interface configured to connect to the network 8 and to communicate with the computer equipment including the PC 3. Note that the USB-I/F 25A supports the USB printer class.

The printing part 26 is a printing mechanism configured to perform printing on the labels. In the template print mode, the printing part 26 synthesizes a print image in which a template is applied to a predefined text or an input text, and prints the print image on the label. The internal clock 27 is a clock built into the second printer 2 and is powered by a battery.

The server 4 is a server capable of providing the template DB and predefined text DB to the first printer 1 and the second printer 2. The user operates the first printer 1 and the second printer 2 to download the template DB and the predefined text DB from the server 4 and store the template DB and the predefined text DB in the memory 12 and the memory 22 of the first printer 1 and the second printer 2, respectively. In a case where the printing is performed on labels which do not use the template data or the predefined text data, the download of the template DB and the predefined text DB is not required. Therefore, the versions of the template DB and predefined text DB stored in first printer 1 may differ from the versions of the template DB and predefined text DB stored in second printer 2.

The first printer 1 and the second printer 2 are each connected to the PC 3 via the network 8. The PC 3 communicates with the first printer 1 or the second printer 2 via the network 8 and is capable of causing each of the first printer 1 and the second printer 2 to perform printing on the labels.

Next, a flow in a case where the printer 1 is in a state where the printing by the first printer 1 is not completed and where the second printer 2 performs the substitute printing for the first printer 1 will be schematically described. The substitute printing refers to such printing performed in a case where the printing based on the print instruction received by the first printer 1 is not completed due to, for example, an error, the second printer 2 performs the printing based on that print instruction in substitution for the first printer 1. In this case, the substitute printing is performed such that the first printer 1 transmits, to the second printer 2, the print instruction which has been transmitted to the first printer 1 by the PC 3, rather than the PC 3 newly transmits, to the second printer 2, the print instruction which the PC 3 previously has transmitted to the first printer 1. Therefore, the communication between the first printer 1 and the second printer 2 is performed via a peer-to-peer connection. In the first embodiment, in a case where the first printer 1 and the second printer 2 transition to a substitution mode which will be described later, and establish the USB connection, the first printer 1 and the second printer 2 are enabled to communicate with each other via a USB cable.

As illustrated in FIG. 3A, the print application is executed in the PC 3. In the template print mode, the PC 3 generates a print instruction including the input text data or the predefined text ID, and the template ID, and transmits the print instruction to the first printer 1. Note that the PC 3 may be configured not to store the template DB or the predefined text DB.

In a case where the print instruction received from the PC 3 includes the input text data, the first printer 1 stores the input text data in the memory 12. In a case wherethe print instruction received from the PC 3 includes the predefined text ID, the first printer 1 extracts predefined text data, associated with the predefined text ID, from the predefined text DB and stores the predefined text data in the memory 12. The first printer 1 extracts template data, associated with the template ID included in the print instruction received from the PC 3, from the template DB and stores the template data in the memory 12. The first printer 1 synthesizes a print image in which the input text indicated by the input text data, or the predefined text indicated by the predefined text data, is applied to the template indicated by the template data. The first printer 1 prints the print image on the label based on the information necessary for printing included in the print instruction.

As illustrated in FIG. 3B, in a case where the first printer 1 is in the state where the printing by the first printer 1 is not completed due to, for example, an error, etc., the user connects the second printer 2 to the first printer 1 via USB. The first printer 1 transmits first data to the second printer 2.

The first data includes the template data, and either the input text data or the predefined text data. The template data is extracted from the template DB based on the template ID included in the print instruction received from the PC 3, and is stored in the memory 12. The input text data is stored in the memory 12 in a case where the print instruction received from the PC 3 includes the input text data. The predefined text data is extracted from the predefined text DB based on the predefined text ID in a case where the print instruction received from the PC 3 includes the predefined text ID, and is stored in the memory 12. Further, the first data includes the information necessary for printing. The information necessary for printing is the information included in the print instruction received from the PC 3.

The second printer 2 stores the received first data in the memory 22. The second printer 2 synthesizes a print image in which the input text indicated by the input text data or the predefined text indicated by the predefined text data is applied to the template indicated by the template data. The second printer 2 prints the print image on the label based on the information necessary for printing.

As illustrated in FIG. 3C, the first printer 1 may transmit second data to the second printer 2, rather than transmitting the first data. The second data is a print image in which the input text indicated by the input text data or the predefined text indicated by the predefined text data is applied to the template indicated by the template data. The second data includes the information necessary for printing.

Whether the first data or the second data is to be transmitted from the first printer 1 to the second printer 2 during the substitute printing is set previously by the specification of the first printer 1. Alternatively, the first printer 1 may be configured such that the substitute application is capable of determining whether the first data or the second data is to be transmitted from the first printer 1 to the second printer 2 during the substitute printing.

The second printer 2 stores the received second data in the memory 22. The second printer 2 prints the print image on the label based on the information necessary for printing.

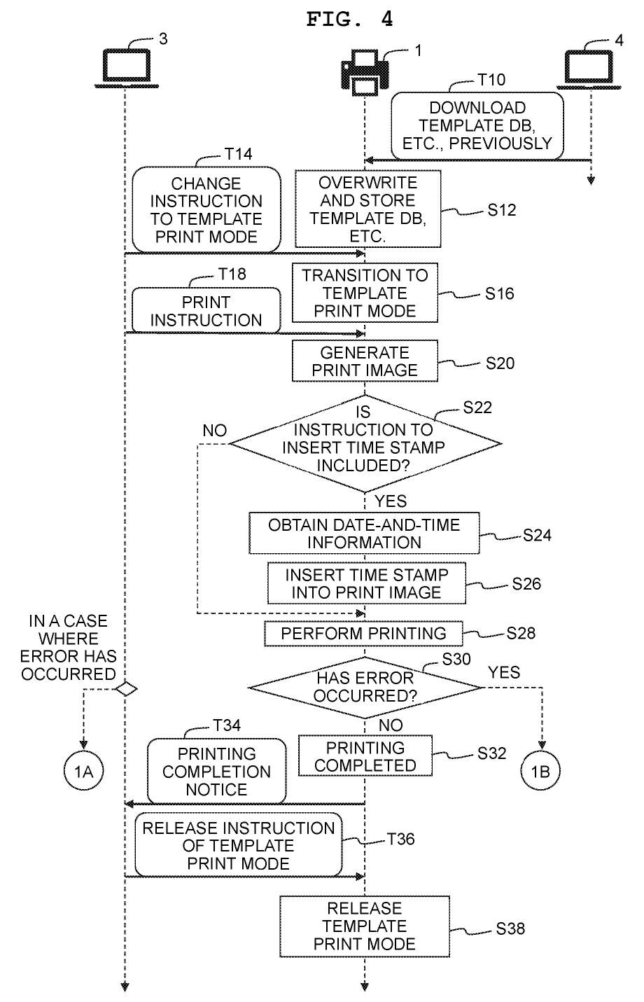

The flow of a process in which the second printer 2 performs the substitute printing for the first printer 1 in the print substitution system 100 of the first embodiment is described, with reference to the sequence diagrams of FIGS. 4 to 12. Note that in the following descriptions of the sequence diagrams, a process performed by the CPU of each of the devices (the PC 3, the printer 1, the printer 2) is described with each of the devices as the subject of the process, rather than describing the CPU of each of the devices as the subject of the process, for the sake of convenience. That is, the processes performed, respectively, by the CPUs 31, 11, and 21 of the PC 3, the first printer 1, and the second printer 2, respectively, are described as the processes performed, respectively, by the PC 3, the first printer 1, and the second printer 2.

Further, in the following description of the sequence diagrams, the communication between or among the devices is executed via the communication parts of the devices, respectively. Specifically, the PC 3 and the first printer 1 communicate via the network 8 connecting the PC 3 and the first printer 1 via the LAN-I/F 35B and the LAN-I/F15B. Therefore, the communication between the PC 3 and the first printer 1 is executed via the LAN-I/F 35B and the LAN-I/F 15B. Furthermore, the PC 3 and the second printer 2 also communicate via the network 8 connecting the PC 3 and the second printer 2 via the LAN-I/F 35B and the LAN-I/F 25B. Therefore, the communication between the PC 3 and the second printer 2 is executed via the LAN-I/F 35B and the LAN-I/F 25B.

In a case where the second printer 2 performs the substitute printing for the first printer 1, the first printer 1 and the second printer 2 are connected via USB, via the USB-I/F 15A and the USB-I/F 25A. Therefore, the communication between the first printer 1 and the second printer 2 is executed via the USB-I/F 15A and the USB-I/F 25A. Thus, the PC 3, the first printer 1, and the second printer 2 communicate via the connection interfaces of the communication part 35, the communication part 15, and the communication part 25, respectively. In the following description, the phrase "via the communication part(s)" in the description of the communication among the devices is omitted, for the sake of convenience.

Note that in the sequence diagrams described below, each step of the process performed in each of the devices is abbreviated as "step S". Further, each timing at which a signal, data, etc., is (are) transmitted or received between or among the devices is abbreviated as "timing T".

As illustrated in FIG. 4, the first printer 1 is capable of performing printing on a label generated simply using the predefined text and the template. In order to make the predefined text and the template usable, the user operates the first printer 1 previously so as to download the template DB and predefined text DB from the server 4 (timing T10). The downloaded template DB and predefined text DB are overwritten and stored in the memory 12 (step S12). That is, each of the template DB and the predefined text DB is updated to the latest version. Note that the download of the template DB and the predefined text DB by the first printer 1 may be performed only once, or may be performed periodically, or may be performed in a case where the template DB and the predefined text DB are updated.

The user starts an application on the PC 3. The application is a program for causing the first printer 1 to perform printing. The user performs an operation to use the first printer 1 in the template print mode. The PC 3 and the first printer 1 are connected to the network 8 via the LAN-I/F 35B and the LAN-I/F 15B. The PC 3 transmits a change instruction, to the first printer 1, to change to the template print mode, via the LAN-I/F 35B in accordance with the operation by the user (timing T14).

Upon receiving the change instruction via the LAN-I/F 15B, the first printer 1 transitions to the template print mode in accordance with the change instruction (step S16).

Next, the user operates the PC 3 to select, in the application, a predefined text to be printed on the label and a template to be applied to the predefined text. The PC 3 generates a print instruction including a predefined text ID of the selected predefined text, and a template ID of the selected template. In a case where any suitable text does not exist as the predefined text, the user can operate the operation part 33 to input an input text. In this case, the PC 3 generates a print instruction including input text data of the input text, and the template ID of the selected template.

Further, the application includes an option to display a time stamp indicating, for example, the date, time, etc., on the print image during the label printing. The time stamp is an image displaying the date, time, etc., in accordance with a predetermined format. In a case where the user enables the option to display the time stamp, an instruction to insert the time stamp into the print image is added to the print instruction.

The PC 3 transmits the generated print instruction to the first printer 1 (timing T18). The first printer 1 receives the print instruction transmitted from the PC 3. The first printer 1 reads the predefined text data, associated with the predefined text ID included in the print instruction, from the predefined text DB and stores the predefined text data in the memory 12. Alternatively, the first printer 1 stores the input text data included in the print instruction in the memory 12. The first printer 1 reads the template data, associated with the template ID included in the print instruction, from the template DB and stores the template data in the memory 12.

The first printer 1 virtually generates, on the memory 12, a print image displaying the predefined text data or the input text data in accordance with a layout defined in the template data (step S20). In a case where the print instruction does not include the instruction to insert a time stamp (step S22: NO), the first printer 1 prints the print image, generated in step S20, on the label (step S28).

In a case where the print instruction includes the instruction to insert the time stamp (step S22: YES), the first printer 1 obtains date-and-time information from the internal clock 17 (step S24). The date-and-time information represents, for example, the current date, time, etc. The first printer 1 generates the time stamp based on the obtained date-and-time information. The first printer 1 inserts the time stamp into the print image generated in step S20, thereby generating a print image including the time stamp (step S26). The first printer 1 prints the print image generated in step S20 or step S26 on the label (step S28).

In a case where the first printer 1 has completed the printing successfully (step S32) without any error occurring during the printing (step S30: NO), the first printer 1 transmits a printing completion notice to the PC 3 (timing T34). Upon receiving the printing completion notice, the PC 3 transmits, to the first printer 1, a release instruction to release the template print mode (timing T36). Upon receiving the release instruction, the first printer 1 releases the template print mode and transitions to the normal print mode (step S38). Thus, in a case where no error occurs during the printing by the first printer 1, the label printing by the first printer 1 is performed in the processes from timing T14 to step S38. Note that at least one of timing T34, timing T36, or step S38 may be omitted.

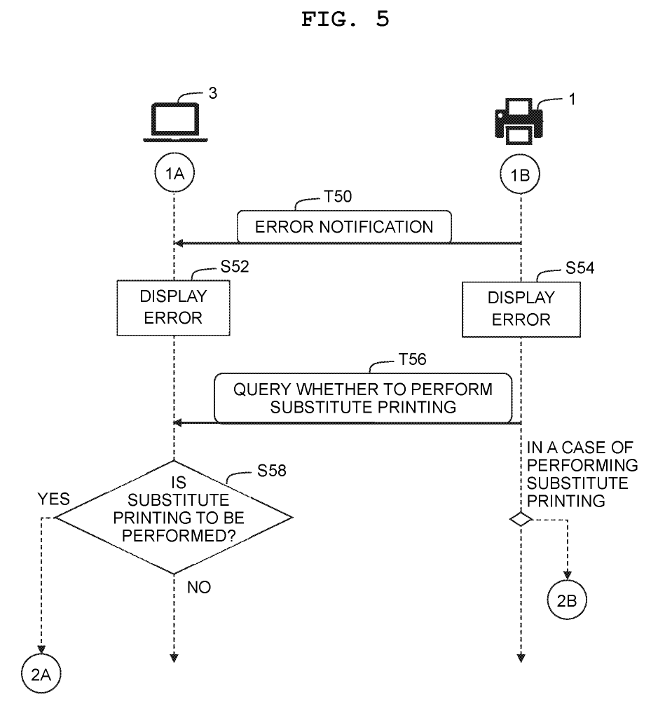

In a case where an error occurs during the label printing by the first printer 1 (step S30: YES), the printing by the first printer 1 is not completed. The flows of the processes in the PC 3 and the first printer 1 shift to lifeline 1A and lifeline 1B, respectively. As illustrated in FIG. 5, the first printer 1 transmits an error notification to the PC 3 to notify the PC 3 of the occurrence of error (timing T50). Upon receiving the error notification, the PC 3 displays a notice indicating that an error has occurred, in the application (step S52). Further, the first printer 1 also displays a notice indicating that an error has occurred, on the display part 14 (step S54). Note that at least one of timing T50, step S52, or step S54 may be omitted.

The error due to which the printing by the first printer 1 is not completed includes a first-kind error and a second-kind error. The first-kind error is relatively easily resolvable, such as in a case where the remaining amount of printable labels becomes zero or a jam occurs while the label is (being) conveyed. The second-kind error is mainly caused by any mechanical malfunction, such as a malfunction in a cutter, or a failure in the conveyance of the labels, and the second-kind error takes longer to be resolved than the first-kind error. The second-kind error is assumed to involve such a case where a part or component is to be replaced and/or repaired by a specialist. In a case where the error notice is displayed on the PC 3 and the first printer 1, the kind of the error is also displayed.

In a case where printing by the first printer 1 is not completed due to the error, the first printer 1 queries the PC 3 whether the user wishes to perform the substitute printing (timing T56). The PC 3 displays a prompt on the display part 34 asking the user whether to perform the substitute printing.

In a case where the user operates the operation part 33 to respond to the PC 3 that the user does not wish to perform the substitute printing (step S58: NO), the PC 3 enters a standby state. In this case, the first printer 1 remains in a state where the printing by the printer based on the print instruction received before the occurrence of the error is not completed. In this state, in a case where, for example, the first-kind error is resolved, the first printer 1 can print the print image stored in the memory 12 on the label and complete the printing. Note that in a case where the first printer 1 receives a new print instruction in a state where the error remains unresolved, the first printer 1 obtains the print instruction, but does not start the printing. In the first embodiment, a state where the printing (by the first printer 1) is not completed includes both a state where printing is interrupted and a state where printing has not started.

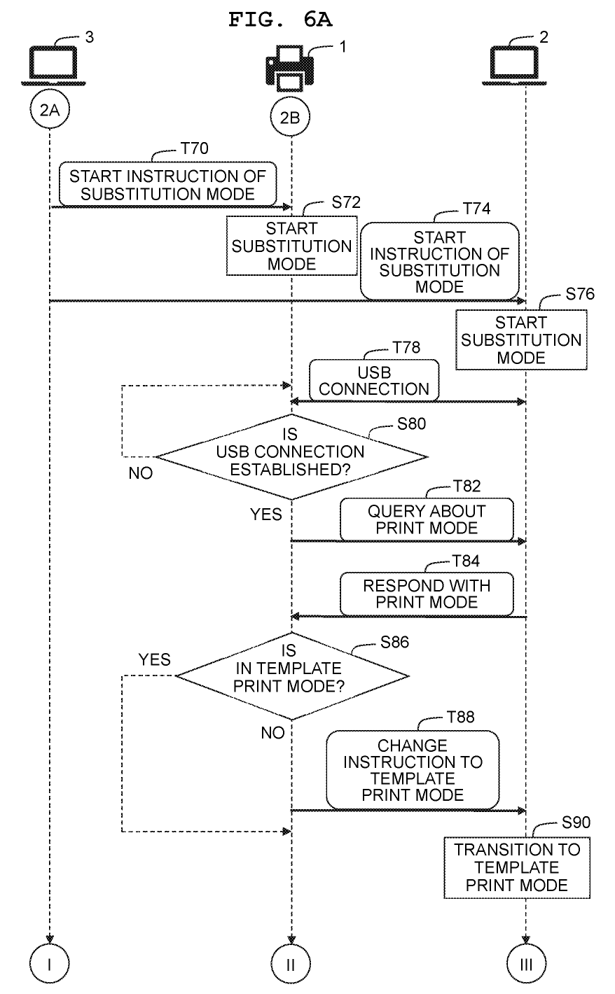

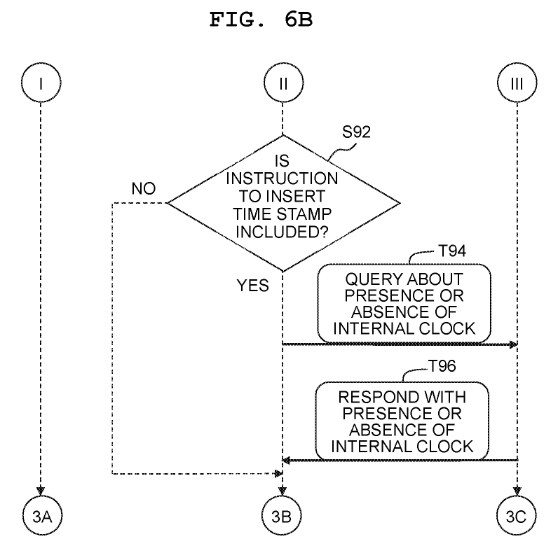

On the other hand, in a case where the user operates the operation part 33 to respond to the PC 3 that the user wish to perform the substitute printing (step S58: YES), the flows of the processes in the PC 3 and the first printer 1 shift from the lifeline 1A and the lifeline 1B to lifeline 2A and lifeline 2B, respectively. As illustrated in FIGS. 6A and 6B, the PC 3 transmits a start instruction to start the substitution mode to the first printer 1 and the second printer 2 (timing T70, timing T74). Upon receiving the start instruction, the first printer 1 and the second printer 2 each start the substitution mode (step S72, step S76). The substitution mode is a mode in which a process for performing the substitute printing is performed.

Note that at least one of step S58, timing T70, step S72, timing T74, or step S76 may be omitted. In a case where step S58, timing T70, step S72, timing T74, and step S76 are omitted, the substitution mode may be automatically started in a case where the USB connection is established at timing T78. Further, in a case where step S58, timing T70, and timing T74 are omitted, the printer 1 and the printer 2 may accept, in step S72 and step S76, respectively, the start instruction to start the substitution mode, in response to the user operating the operation part 13 of the first printer 1.

In a case where substitution mode is started, the first printer 1 stands by until the second printer 2 is connected to the first printer 1 via USB (step S80: NO). The user disconnects the second printer 2, in which the substitution mode has been started, from being connected to the network 8. The user then uses the USB cable so as to connect the second printer 2 to the first printer 1 via USB (timing T78). Note that the second printer 2 may be configured not to be disconnected from the network 8. Further, the second printer 2 which is not originally connected to the network 8 may be used.

In the substitution mode, in a case where another device is connected to the first printer 1 via the USB cable, the first printer 1 attempts to communicatewith the another device via the USB cable. In a case where the second printer 2 which has transitioned to the substitution mode is connected to the first printer 1, the USB-I/F 15A of the first printer 1 identifies the connected device as a communicable device. Once the communication is established between the USB-I/F 15A of the first printer 1 and the USB-I/F 25A of the second printer 2, the first printer 1 determines that the second printer 2 has been connected to the first printer 1. The communication via the USB cable is started between the first printer 1 and the second printer 2. Further, the second printer 2 connects to the PC 3 via the network 8, with the first printer 1 as a bridge.

In a case where the second printer 2 is connected to the first printer 1 via USB (step S80: YES), the first printer 1 queries the second printer 2 about the current print mode of the second printer 2 (timing T82). The second printer 2 responds with the current print mode to the first printer 1 (timing T84).

In a case where the second printer 2 is already in the template print mode(step S86: YES), the flow of the process in the first printer 1 proceeds to step S92. In a case where the second printer 2 is not in the template print mode(step S86: NO), the first printer 1 transmits, to the second printer 2, a change instruction to change to the template print mode(timing T88). Upon receiving the change instruction, the second printer 2 transitions to the template print mode in accordance with the change instruction (step S90). Note that timing T82, timing T84, and step S86 may be omitted.

In a case where the print instruction received from the PC 3 at timing T18 does not include the instruction to insert the time stamp (step S92: NO), the flow of the process in the first printer 1 shifts from the lifeline 2B to a lifeline 3B. In a case where the print instruction includes the instruction to insert the time stamp (step S92: YES), the first printer 1 queries the second printer 2 about the presence or absence of the internal clock 27 (timing T94). The second printer 2 responds to the first printer 1 with the queried presence or absence of the internal clock 27 (timing T96). The first printer 1 stores, in the memory 12, the presence or absence of the internal clock 27 in the second printer 2. The flows of the processes in the PC 3 and the first printer 1 shift from the lifeline 2A and the lifeline 2B to the lifeline 3A and the lifeline 3B, respectively; and the flow of the process in the second printer 2 shift to the lifeline 3C. Note that step S92, timing T94, and timing T96 may be omitted.

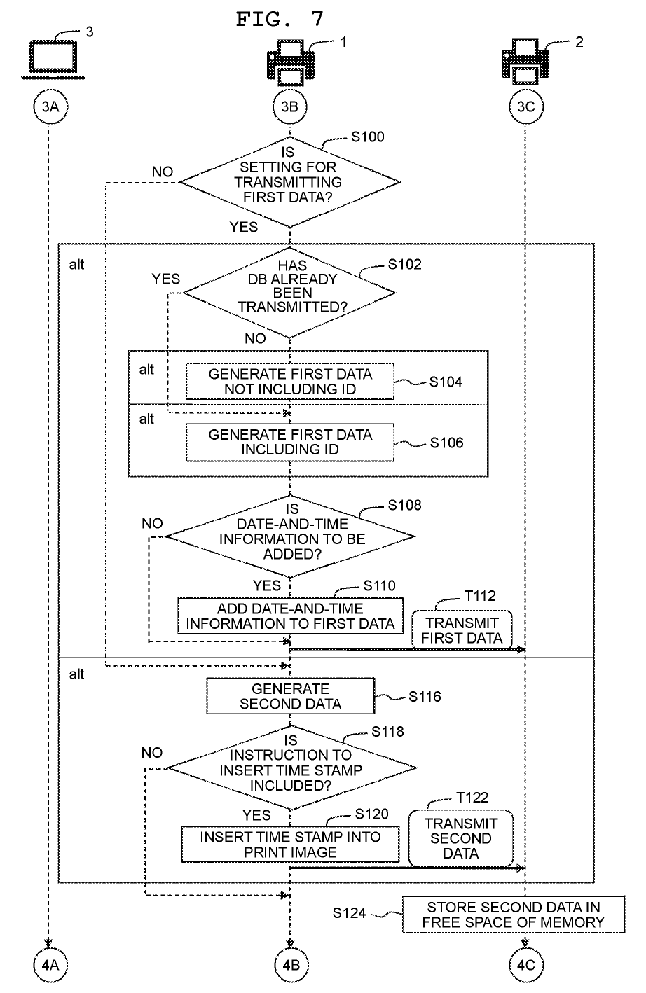

As illustrated in FIG. 7, the first printer 1 determines whether a setting for transmitting data to the second printer 2 is a setting for transmitting the first data to the second printer 2 (step S100). In a case where the setting for transmitting data to the second printer 2 is the setting for transmitting the first data to the second printer 2 (step S100: YES), the first printer 1 determines whether the first printer 1 has already transmitted the database to the second printer 2 (step S102). In a case where the substitute printing is to be continuously performed, the first printer 1 transmits, in some cases, the predefined text DB or the template DB, or both, to the second printer 2 in a process to be described later. In a case where the first printer 1 has not transmitted the database to the second printer 2, as in a case that the substitute printing is to be performed for the first time (step S102: NO), the first printer 1 generates the first data which does not include the ID (step S104). Note that steps S102 and S104 may be omitted. Instead of performing the process of step S102, the first printer 1 may query the second printer 2 about the presence or absence of the database.

As described above, the first data includes the template data and either the input data or the predefined text data. The first data further includes the information necessary for printing. The template data, either input text data or the predefined text data, and the information necessary for printing are stored in the memory 12 in a case where the first printer 1 receives the print instruction at timing T18. The first printer 1 generates the first data including the input text data or the predefined text data, and the template data.

In a case where the first printer 1 has already transmitted the database to the second printer 2 (step S102: YES), such as in a case where the substitute printing is continuously performed, the first printer 1 generates the first data including the ID (step S106). In a case where the first printer 1 has already transmitted the predefined text DB to the second printer 2, the first printer 1 generates the first data including the predefined text ID, but not including the predefined text data. In a case where the first printer 1 has already transmitted the template DB to the second printer 2, the first printer 1 generates first data including the template ID but not including the template data.

The first printer 1 determines whether to add the date-and-time information to the first data (step S108). In a case where the print instruction includes the instruction to insert the time stamp (step S108: YES), and where the second printer 2 does not have the internal clock 27, the first printer 1 adds the date-and-time information to the first data (step S110). The instruction to insert the time stamp into the print image is included in the first data as the information necessary for printing. Note that step S108 may be omitted.

In a case where the print instruction does not include the instruction to insert the time stamp (step S108: NO), or in a case where the second printer 2 has the internal clock 27, the first printer 1 does not add the date-and-time information to the first data. The first printer 1 transmits the first data to the second printer 2 (timing T122). The second printer 2 stores the first data received from the first printer 1 in a free space of the memory 22 (step S124).

Note that steps S92, timing T94, timing T96, and step S108 may be omitted. Further, the first printer 1 may query the second printer 2 about the firmware version at timing T94, and the second printer 2 may respond to the first printer 1 with the firmware version at timing T96. In this case, the first printer 1 may refer to a list of the versions of the firmware having the internal clock 27 so as to confirm the presence or absence of the internal clock 27 in the second printer 2 at step S108.

In a case where, in step S100,the setting for transmitting data to the second printer 2 is a setting for transmitting the second data to the second printer 2 (step S100: NO), the first printer 1 generates the second data (step S116). As described in the foregoing, the second data is a print image. The second data further includes the information necessary for printing. In a case where the print instruction includes the instruction to insert the time stamp (step S118: YES), the first printer 1 inserts the time stamp into the print image generated in step S116 and generates a print image including the time stamp (step S120). The first printer 1 transmits the second data to the second printer 2 (timing T122). The second printer 2 stores the second data received from the first printer 1 in a free space of the memory 22 (step S124). Note that steps S118 and S120 may be omitted.

The flows of the processes in the PC 3, the first printer 1, and the second printer 2 shift from the lifeline 3A, the lifeline 3B and the lifeline 3C to lifeline 4A, lifeline 4B and lifeline 4C, respectively.

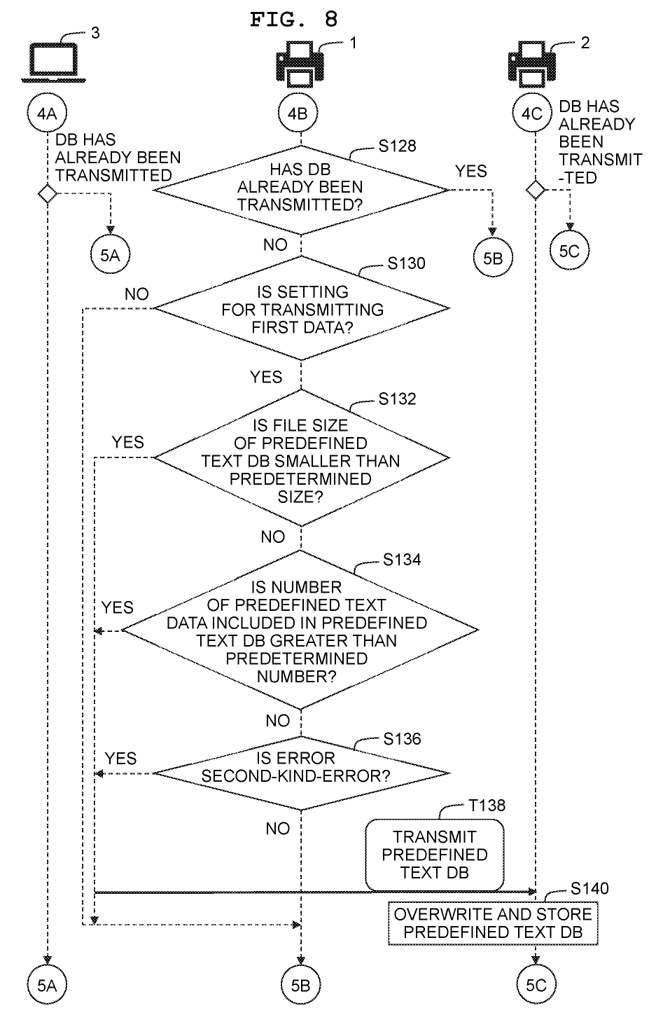

As illustrated in FIG. 8, in a case where the first printer 1 has already transmitted the database to the second printer 2, for example, in a case where the substitute printing is to be continuously performed (step S128: YES), the flows of the processes in the PC 3, the first printer 1, and the second printer 2 shift from the lifeline 4A, the lifeline 4B and the lifeline 4C to lifeline 5A, lifeline 5B and lifeline 5C, respectively. In a case where the first printer 1 has not transmitted the database to the second printer 2 (step S128: NO), for example, in a case where the substitute printing is to be performed for the first time, the first printer 1 determines whether the setting for transmitting the data to the second printer 2 is the setting for transmitting the first data (step S130). In a case where the setting for transmitting data to the second printer 2 is the setting for transmitting the second data (step S130: NO), the first printer 1 does not transmit the predefined text DB to the second printer 2. In this case, the flow of the process in the first printer 1 shifts from the lifeline 4A to the lifeline 5B.

In a case where the setting for transmitting data to the second printer 2 is the setting for transmitting the first data (step S130: YES), the first printer 1 determines whether each of the following three conditions (first condition, second condition, third condition) is satisfied. In a case where the first printer 1 determines that any one of the three conditions is satisfied, the first printer 1 transmits the predefined text DB to the second printer 2. In a case where the first printer 1 determines that none of the three conditions are satisfied, the first printer 1 does not transmit the predefined text DB to the second printer 2. Note that the first printer 1 may determine whether at least one of the three conditions is satisfied.

The first condition is such a condition that the file size of the predefined text DB stored in the memory 12 of the first printer 1 is smaller than a predetermined size. In a case where the file size of the predefined text DB is smaller than the predetermined size, the transmittance of the predefined text DB from the first printer 1 to the second printer 2 does not take much time, and the load on the communication is relatively small. Therefore, in a case where the first condition is satisfied (step S132: YES), the first printer 1 transmits the predefined text DB to the second printer 2 (timing T138).

The second condition is such a condition that the number of the predetermined text data included in the predefined text DB is greater than a predetermined number. In a case where the number of the predetermined text data included in the predefined text DB is greater than the predetermined number, the load on the communication increases each time the predefined text data is transmitted from the first printer 1 to the second printer 2. In this situation, in a case where the second printer 2 has the predefined text DB, the transmittance of the predefined text ID singly from the first printer 1 to the second printer 2 is sufficient, thereby reducing the load on the communication which would otherwise occur each time the predefined text data is transmitted. Therefore, in a case where the second condition is satisfied (step S134: YES), the first printer 1 transmits the predefined text DB to the second printer 2 (timing T138).

The third condition is such a condition that an error occurring in the first printer 1 is the second-kind error. The second-kind errors take longer to be resolved than the first-kind errors. That is, the second printer 2 is highly likely to continuously be used as a substitute for the first printer 1. Also in this situation, in a case where the second printer 2 has the predefined text DB, the transmittance of the predefined text ID singly from the first printer 1 to the second printer 2 is sufficient, thereby reducing the load on the communication which would otherwise occur each time the predefined text data is transmitted. In a case where the third condition is satisfied (timing T136: YES), the first printer 1 transmits the predefined text DB to the second printer 2 (timing T138).

The second printer 2 overwrites and stores the predefined text DB received from the first printer 1 in the memory 22 (step S140). Thus, in a case where the setting for transmitting data to the second printer 2 is the setting for transmitting the first data to the second printer 2 and where any one of the above-described first, second and third conditions is satisfied, the first printer 1 transmits both the first data and the predefined text DB to the second printer 2. In a case where the setting for transmitting data to the second printer 2 is the setting for transmitting the first data to the second printer 2 and where none of the above-described first, second, and third conditions are satisfied, the first printer 1 transmits the first data to the second printer 2. In a case where the setting for transmitting data to the second printer 2 is the setting for transmitting the second data to the second printer 2, the first printer 1 transmits the second data to the second printer 2. The flows of the processes in the PC 3, the first printer 1, and the second printer 2 shift from the lifeline 4A, the lifeline 4B and the lifeline 4C to lifeline 5A, lifeline 5B and lifeline 5C, respectively.

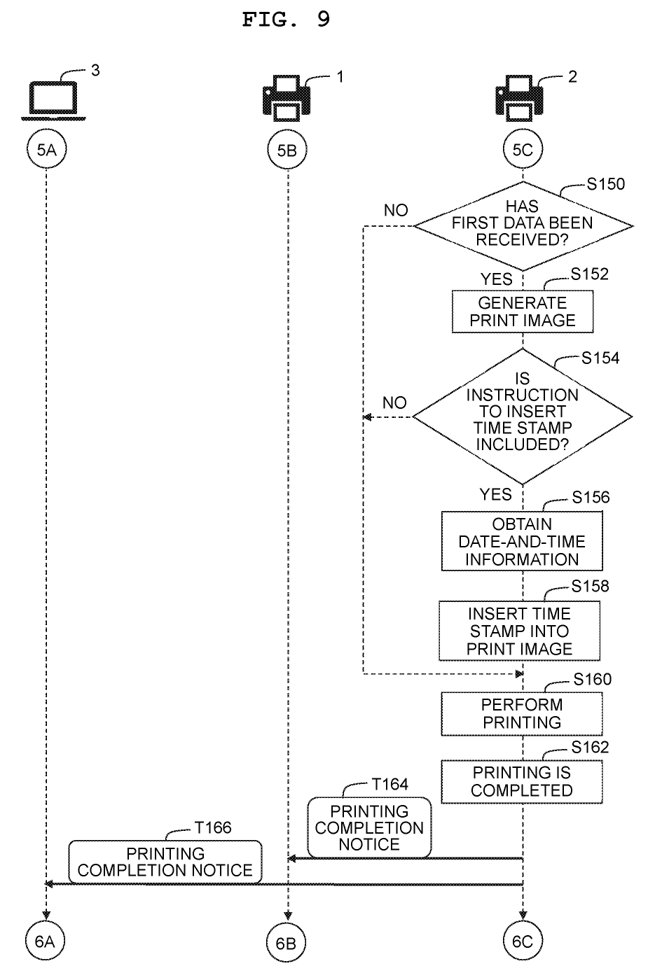

As illustrated in FIG. 9, the second printer 2 determines whether the data received from the first printer 1 at timing T112 or timing T122 is the first data or the second data (step S150). In a case where the printer 2 determines that the second printer 2 has received the second data from the first printer 1 at timing T122 (step S150: NO), the second printer 2 prints the print image included in the second data on the label (step S160). The print image in the second data includes the time stamp, in a case where the print instruction includes the instruction to insert the time stamp.

On the other hand, in a case wherethe printer 2 determines that the second printer 2 has received the first data from the first printer 1 at timing T112 (step S150: YES), the second printer 2 generates a print image based on the first data.

In a case where the second printer 2 stores the template DB in the memory 22, the second printer 2 stores, in the memory 22, the template data associated with the template ID included in the first data. In a case where the second printer 2 does not store the template DB in the memory 22, the second printer 2 stores, in the memory 22, the template data included in the first data. In a case where the second printer 2 stores the predefined text DB in the memory 22, the second printer 2 stores, in the memory 22, the predefined text data associated with the predefined text ID included in the first data. In a case where the second printer 2 does not store the predefined text DB in the memory 22, the second printer 2 stores, in the memory 22, the predefined text data included in the first data. In a case where the first data includes input text data, the second printer 2 stores the input text data in the memory 22.

The second printer 2 virtually generates, on the memory 22, a print image displaying the predefined text data or the input text data in accordance with a layout defined in the template data (step S152). In a case where the first data does not include the instruction to insert the time stamp (step S154: NO), the second printer 2 prints the print image generated in step S152 on the label (step S160).

In a case where the information necessary for printing included in the first data includes the instruction to insert the time stamp (step S154: YES), the second printer 2 obtains the date-and-time information (step S156). In a case where the second printer 2 has the internal clock 27, the second printer 2 obtains the date-and-time information from the internal clock 27. In a case where the second printer 2 does not have the internal clock 27, the second printer 2 obtains the date-and-time information added to the first data in step S110. The second printer 2 generates the time stamp based on the obtained date-and-time information. The second printer 2 inserts the time stamp into the print image generated in step S152, thereby generating a print image including the time stamp (step S158). Note that steps S154, S156, and S158 may be omitted.

The second printer 2 prints the print image generated in step S152 or step S158, or the print image of the second data, on the label (step S160). Upon completing the printing (step S162), the second printer 2 transmits the printing completion notice to the first printer 1 (timing T164). Further, the second printer 2 transmits the printing completion notice to the PC 3 via the network 8 to which the second printer 2 is connected via the first printer 1 as the bridge (timing T166). The flows of the processes in the PC 3, the first printer 1, and the second printer 2 shift from the lifeline 5A, the lifeline 5B and the lifeline 5C to lifeline 6A, lifeline 6B and lifeline 6C, respectively. Note that at least one of step S164 or step S166 may be omitted.

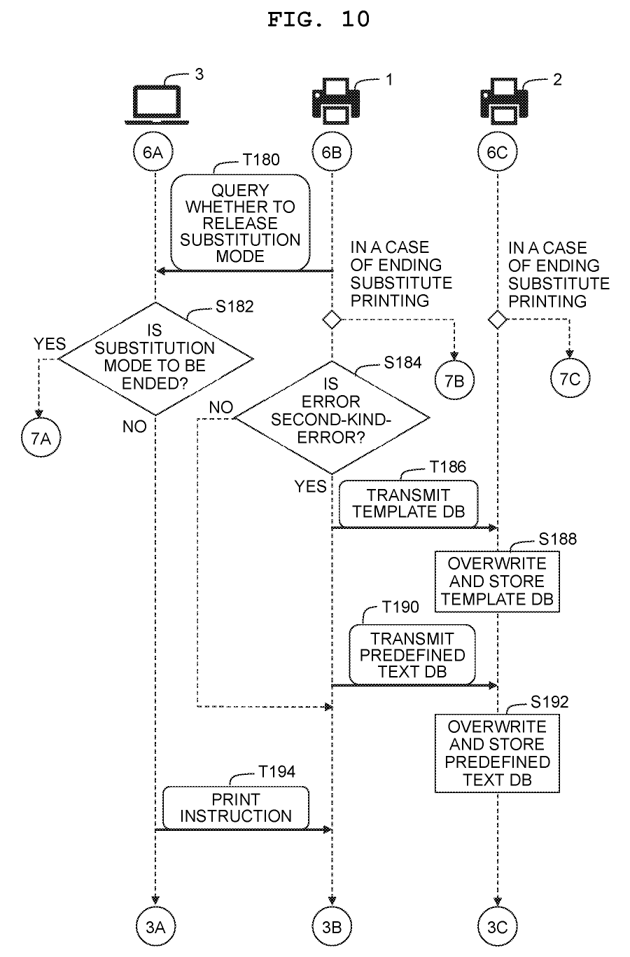

As illustrated in FIG. 10, the first printer 1 queries the PC 3 as to whether to release the substitution mode (timing T180). In a case where the user operates the operation part 33 to respond to the first printer 1 that the user does not wish to release the substitution mode in order to continue the substitute printing (step S182: NO), the PC 3 stands by for the printing to be performed on the next label. In a case where the error occurred in the first printer 1 is the first-kind error (step S184: NO), the first printer 1 stands by to receive a new print instruction from the PC 3. Note that timing T180 and step S182 may be omitted. Further, the process of step S182 may be performed by the first printer 1.

In a case where the error occurred in the first printer 1 is the second-kind error (step S184: YES), the first printer 1 transmits the template DB to the second printer 2 (timing T186). The second printer 2 overwrites and stores the template DB received from the first printer 1 in the memory 22 (step S188). Further, the first printer 1 transmits the predefined text DB to the second printer 2 (timing T190). The second printer 2 overwrites and stores the predefined text DB received from the first printer 1 in the memory 22 (step S192). In the processes from timing T186 to step S192, the second printer 2 consequently has the template DB and the predefined text DB which are the same as the template DB and the predefined text DB of the first printer 1.

In the processes from timing T186 to step S192, the template DB and the predefined text DB include a template ID and a predefined text ID, respectively, which are different from the template ID and the predefined text ID corresponding to the print instruction at timing T18. Note that at least one of step S184, timing T186, or timing T190 may be omitted.

In a case where the new print instruction is generated in the PC 3, the PC 3 transmits the new print instruction to the first printer 1 (timing T194). The flows of the processes in the PC 3, the first printer 1, and the second printer 2 shift from the lifeline 6A, the lifeline 6B and the lifeline 6C to the lifeline 3A, lifeline 3B and the lifeline 3C, respectively. The second printer 2 receives the first data or the second data from the first printer 1 and performs the substitute printing for the first printer 1.

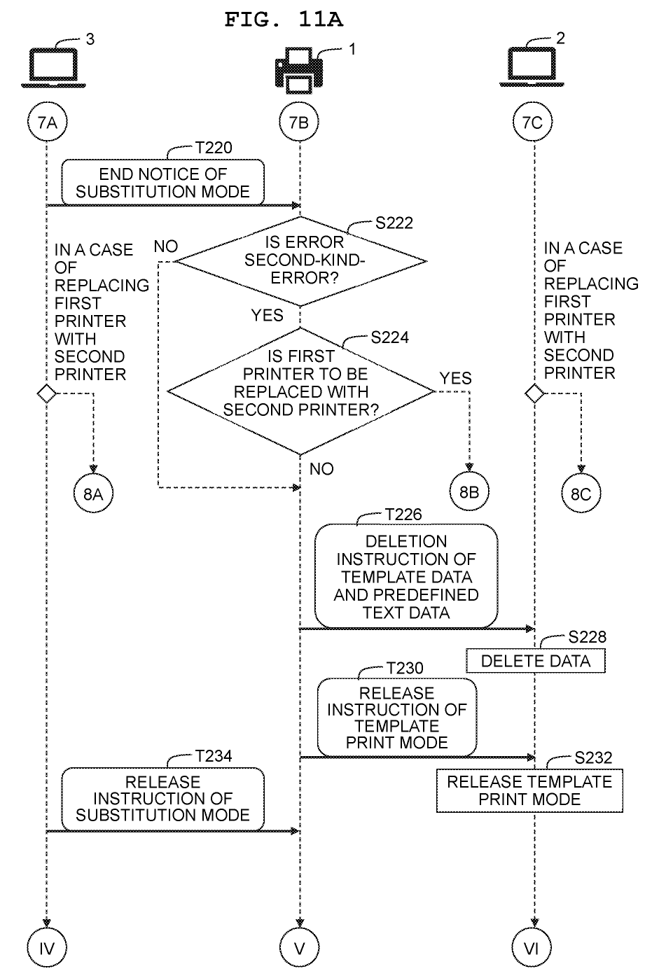

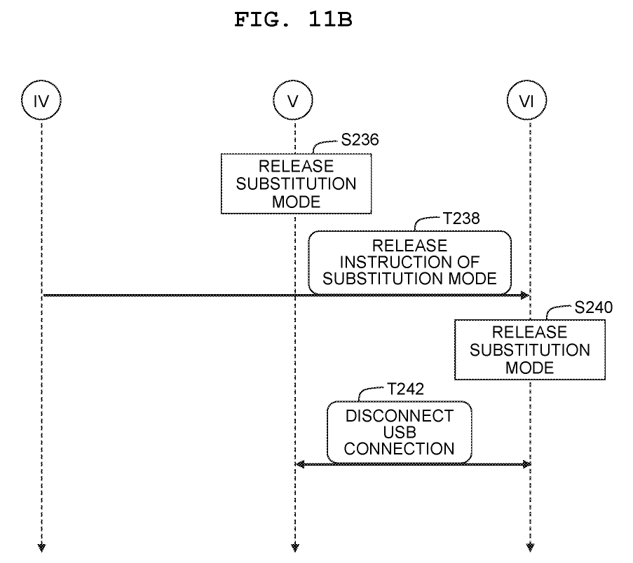

In a case where the user responds to the first printer 1 in step S182 to release the substitute printing so as to end the substitution mode (step S182: YES), the flows of the processes in the PC 3, the first printer 1, and the second printer 2 shift from the lifeline 6A, the lifeline 6B and lifeline 6C to lifeline 7A, lifeline 7B, and lifeline 7C, respectively. As illustrated in FIGS. 11A and 11B, the PC 3 transmits an end notice for ending the substitution mode to the first printer 1 (timing T220). Note that timing T220 may be omitted.

Upon receiving the end notice for ending the substitution mode, the first printer 1 determines whether the error which has occurred is the first-kind error or the second-kind error (step S222). In a case where the first printer 1 determines that the error is the second-kind error (step S222: YES), the first printer 1 accepts, from the PC 3, a response regarding whether to replace the first printer 1 with the second printer 2 and to cause the second printer to perform the printing (step S224). That is, the first printer 1 accepts a response, from the PC 3, regarding whether the printing is to be performed directly from the second printer 2 as a replacement device replacing the first printer 1, rather than causing the second printer 2 to perform the substitute printing for the first printer 1. The first printer 1 causes the display part 14 to display a screen to accept a response regarding whether the first printer 1 is to be replaced with the second printer 2 as the replacement device, and the first printer 1 accepts a response from the user, via the operation of the operation part 13 by the user. Note that at least one of step S222 or step S224 may be omitted.

In a case where the error is the first-kind error (step S222: NO), or in a case where the user responds that the user does not wish to replace the first printer 1 with the second printer 2 as the replacement device (step S224: NO), the first printer 1 transmits, to the second printer 2, a deletion instruction to delete the template data and the predefined text data stored in the substitute printing (timing T226). Upon receiving the deletion instruction from the first printer 1, the second printer 2 deletes the template data and predefined text data stored in the memory 22 (step S228). Note that at least one of timing T226 or step S228 may be omitted.

The first printer 1 transmits, to the second printer 2, the release instruction to release the template print mode (timing T230). Upon receiving the release instruction, the second printer 2 releases the template print mode and transitions to the normal print mode (step S232). Note that at least one of timing T230 or step S232 may be omitted.

The PC 3 transmits the release instruction to release the substitution mode to the first printer 1 and the second printer 2 (timing T234, timing T238). Upon receiving the release instruction, each of the first printer 1 and the second printer 2 releases the substitution mode (step S236, step S240). The user disconnects the USB cable connecting the first printer 1 and the second printer 2, disconnecting the USB connection (timing T242) between the first and second printers 1 and 2. In this manner, in a case where the substitution mode is released without replacing the first printer 1 with the second printer 1 as the replacement device, the second printer 2 deletes the template data and the predefined text data received from the first printer 1. Note that at least one of timing T234 or timing T238 may be omitted. In this case, upon detecting the disconnection of the USB connection at timing T242, the first printer 1 may perform the process of step S236 and the second printer 2 may perform the process of step S240.

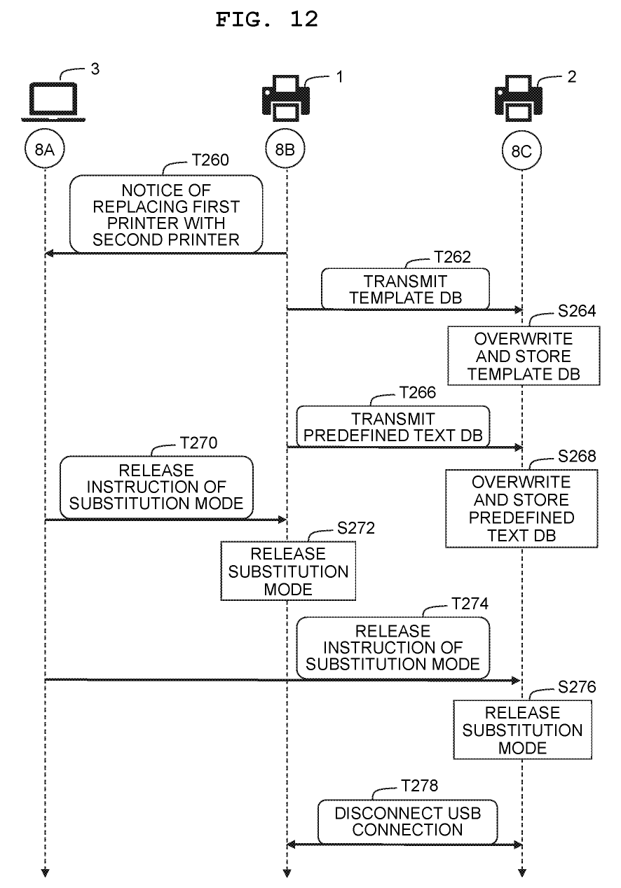

In a case where the substitution mode is to be released, and wherethe user responds indicating that the first printer 1 to be replaced with the second printer 2 as the replacement device (step S224: YES), the flows of the processes in the PC 3, the first printer 1, and the second printer 2 shift from the lifeline 7A, the lifeline 7B and the lifeline 7C to lifeline 8A, lifeline 8B and lifeline 8C, respectively. As illustrated in FIG. 12, the first printer 1 transmits, to the PC 3, a notice to notify the PC 3 that the first printer 1 is to be replaced with the second printer 2 as the replacement device (timing T260).

The first printer 1 transmits the template DB to the second printer 2 (timing T262). The second printer 2 overwrites and stores the template DB received from the first printer 1 in the memory 22 (step S264). Further, the first printer 1 transmits the predefined text DB to the second printer 2 (timing T266). The second printer 2 overwrites and stores the predefined text DB, received from the first printer 1, in the memory 22 (step S268). In the processes from timing T262 to step S268, the second printer 2 consequently has the same template DB and the predefined text DB as the template DB and the predefined text DB of the first printer 1. In the processes from timing T262 to step S268, the template DB and the predefined text DB include a template ID and a predefined text ID, respectively, which are different from the template ID and the predefined text ID corresponding to the print instruction at timing T18.

The PC 3 transmits the release instruction to release the substitution mode to the first printer 1 and the second printer 2 (timing T270, timing T274). Upon receiving the release instruction, each of the first printer 1 and the second printer 2 releases the substitution mode (step S272, step S276). Thus, in a case where the first printer 1 is to be replaced with the second printer 2 as the replacement device in such a manner, the second printer 2 consequently has the template DB and predefined text DB which are the same as the template DB and the predefined text DB of the first printer 1 during timing T270 to step S276. The user disconnects the USB cable connecting the first printer 1 and the second printer 2, disconnecting the USB connection (timing T278). The PC 3 transmits a print instruction to the second printer 2 connected via the network 8. The second printer 2, acting as a replacement device for the first printer 1, is then capable of performing printing on the label.

Note that timing T260 may be omitted. Further, at least one of timing T270 or timing T274 may be omitted. In this case, each of the first printer 1 and the second printer 2 may detect the disconnection of the USB connection at timing T278, and the first printer 1 may perform the process of step S272 and the second printer 2 may perform the process of step S276.

As described above, the first printer 1 generates the first data including the template data and either the input data or the predefined text data, and transmits the first data to the second printer 2. Alternatively, the first printer 1 transmits, to the second printer 2, the second data indicating the print image based on the template data and either the input data or the predefined text data. Therefore, even in a case where the second printer 2 does not have the template data, the second printer 2 is capable of printing, on the label, an appropriate print image based on the first data or the second data. Thus, the first printer 1 contributes to causing the second printer 2 to print, on the label, the appropriate print image based on the first data or the second data.

After transmitting the first data or the second data to the second printer 2, the first printer 1 transmits the template DB to the second printer 2. That is, during the substitute printing performed for the first time, the first printer 1 transmits the first data or second data to the second printer 2 so that the substitute printing can be performed smoothly. Further, for the substitute printing performed subsequently, the first printer 1 transmits the template DB to the second printer 2 so that the substitute printing can be performed further smoothly. Therefore, the first printer 1 contributes to causing the second printer 2, as the substitute for the first printer 1, to print, on the label, the appropriate print image based on the print instruction.

The predefined text data is associated with the predefined text ID in the predefined text DB. The first printer 1 identifies the predefined text data from the predefined text DB based on the predefined text ID included in the print instruction. The first printer 1 transmits, to the second printer 2, the first data including the predefined text data which is identified based on the predefined text ID, and the template data which is associated with the template ID. Alternatively, the first printer 1 transmits, to the second printer 2, the second data indicating the print image in which the predefined text indicated by the predefined text data is applied to the template indicated by the template data. Thus, the first printer 1 contributes to causing the second printer 2 to print, on the label, the appropriate print image based on either the first data or the second data.

After the second printer 2 has performed the substitute printing based on the first data or the second data, the first printer 1 transmits the predefined text DB to the second printer 2. Consequently, in the next substitute printing, in a case where the second printer 2 receives the first data including the predefined text ID from the first printer 1, the second printer 2 is capable of extracting, from the predefined text DB, the predefined text data associated with the predefined text ID. Thus, the first printer 1 contributes to causing the second printer 2, as the substitute for the first printer 1, to print, on the label, the appropriate print image based on the first data or the second data.

The first condition is such a condition that the file size of the predefined text DB is smaller than the predetermined size. The predefined text DB with a file size equal to or larger than the predetermined size takes longer to be transmitted from the first printer 1 to the second printer 2, as compared to the predefined text DB of which size is smaller than the predetermined size. Therefore, in a case where the first condition is not satisfied, the necessity to transmit the predefined text DB to the second printer 2 is low. Thus, the first printer 1 is configured to transmit the predefined text DB to the second printer 2 in a case where the first condition is satisfied, thereby contributing to causing the second printer 2 to perform the substitute printing smoothly.

The second condition is such a condition that the number of the predefined text data included in the predefined text DB is greater than the predetermined number. In a case where the number of the predefined text data associated with the predefined text IDs is less than the predetermined number, the transmission of the predefined text data to the second printer 2 each time the printing is performed does not take significant time. Therefore, in a case where the second condition is not satisfied, the necessity to transmit the predefined text DB to the second printer 2 in advance is low. Thus, the first printer 1 is configured to transmit the predefined text DB to the second printer 2 in a case where the second condition is satisfied, thereby contributing to causing the second printer 2 to perform the substitute printing smoothly.

The third condition is such a condition that the error occurring in the first printer 1 is the second-kind error. In a case where the error occurring in the first printer 1 is the first-kind error, resolving the error does not take time. That is, using the second printer 2 as the substitute for the first printer 1 is merely for the short period until the error is resolved. Therefore, in a case where the third condition is not satisfied, the necessity of transmitting the predefined text DB in advance to the second printer 2 is low. Thus, the first printer 1 is configured to transmit the predefined text DB to the second printer 2 in a case where the third condition is satisfied, thereby contributing to performing the substitute printing smoothly.

In a case where the print instruction includes the input text per se rather than the predefined text ID, the first printer 1 transmits the first data including the input text data to the second printer 2. Alternatively, the first printer 1 transmits the second data, which indicates the print image generated using the input text data, to the second printer 2. Upon receiving the first data, the second printer 2 is capable of generating a print image in which the input text is applied to the template, without extracting the predefined text data based on the predefined text ID. Therefore, the first printer 1 contributes to causing the second printer 2, as the substitute for the first printer 1, to print an appropriate print image based on the first data or the second data on the label.

In a case where the second printer 2 is to be used to replace the first printer 1, the first printer 1 transmits the template DB of the first printer 1 to the second printer 2. The second printer 2 overwrites and stores the template DB received from the first printer 1 in the memory 22. The latest template DB is stored in the memory 22. The second printer 2 is capable of extracting an appropriate template from the latest template DB. Therefore, the first printer 1 contributes to causing the second printer 2, as the substitute for the first printer 1, to print an appropriate print image based on the first data or the second data on the label.

In a case where the second printer 2 is used to replace the first printer 1, the first printer 1 transmits the predefined text DB to the second printer 2. The second printer 2 overwrites and stores the predefined text DB received from the first printer 1 in the memory 22. The latest predefined text DB is stored in the memory 22. The second printer 2 is capable of extracting an appropriate predefined text from the latest predefined text DB. Therefore, the first printer 1 contributes to causing the second printer 2, as the substitute for the first printer 1, to print an appropriate print image based on the first data or the second data, on the label.

In a case where the error due to which the printing by the first printer 1 is not completed is the first-kind error, the error is expected to be resolved quickly. Therefore, the second printer 2 is not expected to be used as the replacement of the first printer 1 continuously for a long period of time. In a case where the error due to which the printing by the first printer 1 is not completed is the second-kind error, the resolution of the error is expected to take time. In this case, the second printer 2 is used to replace the first printer 1. Thus, the first printer 1 is replaced with the second printer 2, thereby contributing to printing an appropriate print image based on the print instruction, on the label.

The USB-I/F 15A of the first printer 1 attempts to communicate with the device connected to the first printer 1 via the USB cable. In a case where the connection is established between the USB-I/F 15A and the USB-I/F 25A, the first printer 1 determines that the second printer 2 is connected the first printer 1. With this, the first printer 1 is able to easily determine the connection with the second printer 2. Therefore, the first printer 1 contributes to causing the second printer 2, as the substitute for the first printer 1, to print, on the label, the appropriate print image based on the print instruction.

In a case where the second printer 2 has the internal clock 27, the second printer 2 is capable of obtaining the date-and-time information from the internal clock 27. Even in a case where the second printer 2 does not have the internal clock 27, the second printer 2 is capable of obtaining the date-and-time information from the first printer 1 by receiving the first data. Alternatively, the second printer 2 is capable of obtaining the print image, in which the date-and-time information is added, by receiving the second data. Therefore, the first printer 1 contributes to causing the second printer 2, as the substitute for the first printer 1, to print the appropriate print image based on the print instruction, on the label.

In a case where the first printer 1 is connected to the second printer 2, the first printer 1 is capable of querying the second printer 2 about the print mode of the second printer 2. In a case where the second printer 2 is not in the template print mode, the first printer 1 is capable of instructing the second printer 2 to transition to the template print mode. Consequently, the second printer 2 is capable of generating a print image in which the predefined text or the input text is applied to the template. Thus, the first printer 1 contributes to causing the second printer 2, as the substitute for the first printer 1, to print the appropriate print image based on the print instruction, on the label.

The first printer 1 is capable of querying the user as to whether to replace the first printer 1 with the second printer 2. In a case where the user does not wish to replace the first printer 1 with the second printer 2, the first printer 1 is capable of cancelling and releasing the transition of the second printer 2 to the template print mode. With this, the first printer 1 is capable of returning the second printer 2 to be in the mode before the second printer 2 has been connected to the first printer 1.

The second printer 2 receives, from the first printer 1, the first data including the template data and either the input data or the predefined text data. Alternatively, the second printer 2 receives, from the first printer 1, the second data indicating the print image based on the template data and either the input data or the predefined text data. Therefore, even in a case where the second printer 2 does not have the template data, the second printer 2 is capable of printing, on the label, an appropriate print image based on the first data or the second data. Thus, the second printer 2 contributes to printing, on the label, the appropriate print image based on the print instruction, as the substitute for the first printer 1.

The second printer 2 overwrites and stores the template DB and the predefined text DB received from the first printer 1 in the memory 22. Therefore, the latest template DB and the latest predefined text DB are stored in the memory 22. The second printer 2 is capable of extracting an appropriate predefined text and an appropriate template from the latest predefined text DB and the latest template DB, respectively. Therefore, the second printer 2 contributes to printing an appropriate print image based on the print instruction on the label, as the substitute for the first printer 1.

Even in a case where the second printer 2 does not have the internal clock 27, the second printer 2 is capable of receiving the first data so as to obtain the date-and-time information which has been obtained by the first printer 1 from the internal clock 17 of the first printer 1. Alternatively, the second printer 2 is capable of obtaining the second data so as to obtain the print image in which the date-and-time information is added. Therefore, the second printer 2 is capable of obtaining the print image in which the predefined text or the input text is applied to the template and to which the date-and-time information is added. Thus, the second printer 2 contributes to printing, on the label, an appropriate print image based on the print instruction, as the substitute for the first printer 1.

In the first embodiment, the label is an example of a "print medium" of the present disclosure. The first printer 1 is an example of a "printing apparatus" in the first aspect and fourth aspect of the present disclosure, and is an example of "another printing apparatus" in the second aspect and third aspect of the present disclosure. The input text and the predefined text are each an example of "print content" of the present disclosure.

The memory 12 is an example of a "first memory" of the present disclosure. The printing part 16 is an example of a "printing mechanism" in the first aspect and fourth aspect of the present disclosure. The communication part 15 is an example of a "communication interface" in the first aspect and fourth aspect of the present disclosure. The CPU 11 is an example of a "processor" in the first aspect and fourth aspect of the present disclosure.

The inputted text data and the predefined text data are each an example of "print content data" in the present disclosure. The inputted text per se and the predefined text ID are each an example of "related information" in the present disclosure. The process in which the first printer 1 receives the print instruction at timing T18 is an example of an "obtaining process" of the present disclosure. The process in which the first printer 1 performs printing in step S28 is an example of a "first printing process" of the present disclosure.

The second printer 2 is an example of the "another printing apparatus" in the first aspect and fourth aspect of the present disclosure, and an example of the "printing apparatus" in the second aspect and third aspect of the present disclosure. The process in which the first printer 1 transmits the first data to the second printer 2 at timing T112, and the process in which the first printer 1 transmits the second data to the second printer 2 at timing T122 are an example of a "first transmitting process" of the present disclosure. Further, the process in which the first printer 1 transmits the predefined text DB to the second printer 2 at timing T138, timing T190, and timing T266, and the process in which the first printer 1 transmits the template DB to the second printer 2at timing T190 and timing T262, are also examples of the "first transmitting process" of the present disclosure.

The process in which the first printer 1 transmits the template DB to the second printer 2 at timing T186 and timing T262 is an example of a "second transmitting process" of the present disclosure. The predefined text ID is an example of "identification information" of the present disclosure. The predefined text DB is an example of a "print content database" of the present disclosure.

The process in which the first printer 1 transmits the predefined text DB to the second printer 2 at timing T190 is an example of a "third transmitting process" of the present disclosure. The process in which the first printer 1 accepts the response(, from the PC 3,) as to whether the first printer is to be replaced with the second printer 2 at step S224 is an example of an "accepting process" of the present disclosure. The various devices including the second printer 2 are each an example of "another printing apparatus" of the present disclosure. The USB-I/F 15A is an example of a "connection interface" of the present disclosure.

The process in which the first printer 1 obtains the date-and-time information in step S24 is an example of a "date-and-time obtaining process" of the present disclosure. The process in which the first printer 1 queries the second printer 2 about the presence or absence of the internal clock at timing T94 is an example of a "first querying process" of the present disclosure. The time stamp is an example of a "date-and-time image" of the present disclosure.

The memory 22 is an example of a "memory" of the another printing apparatus in the first aspect of the present disclosure. The process in which the first printer 1 queries the second printer 2 about the print mode of the second printer 2 at timing T82 is an example of a "second querying process" of the present disclosure. The process in which the first printer 1 transmits, to the second printer 2, the change instruction to the template print mode at timing T88 is an example of a "mode transition process" of the present disclosure. The process in which the first printer 1 transmits, to the second printer 2, the release instruction to release the template print mode at timing T230 is an example of a "transition canceling process" of the present disclosure.

The communication part 25 is an example of the "communication interface" in the second aspect of the present disclosure. The printing part 26 is an example of the "printing mechanism" in the second aspect of the present disclosure. The CPU 21 is an example of the "processor" in the second aspect of the present disclosure.

The process in which the second printer 2 receives the first data at timing T112 and the process in which the second printer 2 receives the second data at timing T122 are each an example of a "first receiving process" of the present disclosure. Further, the process in which the second printer 2 receives the predefined text DB at timing T138, timing T190, and timing T266, and the process in which the second printer 2 receives the template DB at timing T190 and timing T262, are also examples of the "first receiving process" of the present disclosure. The process in which the second printer 2 performs printing in step S160 is an example of a "second printing process" of the present disclosure. The memory 22 is an example of a "second memory" of the present disclosure. The process in which the second printer 2 overwrites and stores the template DB and the predefined text DB in the memory 22 in steps S188, S192, S264, and S268 is an example of a "storing process" of the present disclosure.

The present disclosure is not limited to the first embodiment, and various modifications are possible. The PC 3 is not limited to a personal computer. The PC 3 may also be, for example, a smartphone, a PDA, a tablet terminal, etc. The first printer 1 and the second printer 2 may use, for example, an ASIC, a FPGA (Field Programmable Gate Array), etc., as the processor, rather than using the CPU 11 and the CPU 21, respectively. Although the predefined text or the input text is applied to the template, the present disclosure is not limited to this. With respect to a template using a layout displaying two or more predefined texts or two or more input texts, the two or more predefined texts or the two or more input texts may be applied to the template. The inputted text or the predefined text is defined as the print content, but an image may also be included in the print content.

Although the first printer 1 and the second printer 2 communicates with each other via the USB cable in a case where the substitute printing is performed, the LAN-I/F 15B of the first printer 1 and the LAN-I/F 25B of the second printer 2 may be connected to each other via a LAN cable so as to cause the first printer 1 and the second printer 2 to communicate peer-to-peer.

The communication part 15 of the first printer 1 and the communication part 25 of the second printer 2 may each include a wireless LAN connection interface. In a case where the substitute printing is performed, the first printer 1 and the second printer 2 may be connected with each other in the wireless LAN ad hoc mode, and may be communicated with each other peer-to-peer in a case where the substitute printing is performed. Alternatively, in a case where the substitute printing is performed, the first printer 1 and the second printer 2 may be connected with each other via Wi-Fi Direct of the wireless LAN, and may be communicated with each other peer-to-peer. The communication part 15 of the first printer 1 and the communication part 25 of the second printer 2 may each include a Bluetooth connection interface (Bluetooth is registered trademark of Bluetooth SIC. Inc.). In a case where the substitute printing is performed, the first printer 1 and the second printer 2 may be connected to each other via Bluetooth.

The first printer 1 may transmit the template data to the second printer 2 at all times in the substitute printing, rather than transmitting the template DB to the second printer 2. The first printer 1 may transmit the prescribed text data to the second printer 2 at all times in the substitute printing, rather than transmitting the prescribed text DB to the second printer 2. The first printer 1 may be configured not to add the date-and-time information to the print image. Alternatively, the PC 3 may include the date-and-time information in the print instruction and transmit, to the first printer 1, the print instruction in which the data-and-time information is included. Although the first printer 1 inserts the time stamp into the print image of the second data, the second printer 2 may insert the time stamp into the print image of the second data.

The print substitution system 100 may be configured not to include the PC 3. In this case, the first printer 1 may obtain the print instruction generated by the user operating the operation part 13, and may perform printing on the label and may cause the second printer 2 to perform the substitute printing for the first printer 1. Further, a reading device configured to read a code image in which the template ID and the predefined text ID are encoded may be connected to the first printer 1. In this case, the first printer 1 may obtain the print instruction from this reading device. Furthermore, the notice, etc., transmitted by the first printer 1 to the PC 3 in the first embodiment may be displayed on the display part 14. The query, etc., transmitted by the first printer 1 to the PC 3 in the first embodiment may be displayed on the display part 14, and the operation part 13 may accept input of the response by the user.

Although the first printer 1 generates the first data including the predefined text ID and the template ID in step S106, the first printer 1 may transmit the print instruction as the first data to the second printer 2 in step S106.

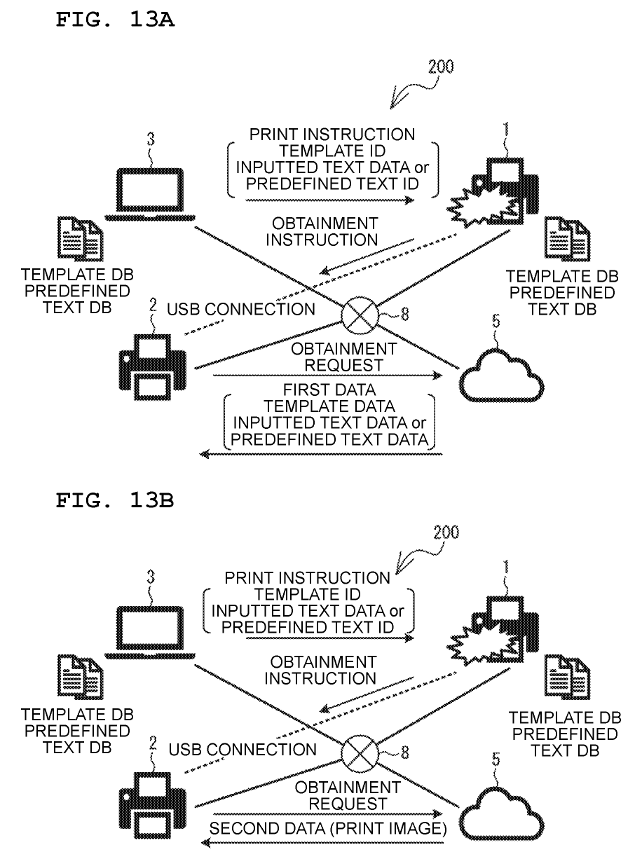

Next, the second embodiment of the present disclosure will be described. As illustrated in FIGS. 13A and 13B, a print substitution system 200 according to the second embodiment includes a PC 3, a first printer 1, and a second printer 2. The PC 3, the first printer 1, and the second printer 2 are connected to the same segment of a network 8. The PC 3 is capable of causing each of the first printer 1 and the second printer 2 to perform printing, via the network 8.

The network 8 is connected to the Internet. A content server 5 is disposed on the Internet. The contents server 5 is a server which provides template data and predefined text data. In a case where a certain printer, as a target to which the template data and the prescribed text data are provided, is registered, the content server 5 manages the operational status of the certain printer. Note that the network 8 may also be a local area network.

The content server 5 is capable of providing different kinds of template data and different kinds of predefined text data for each of the segments to which a corresponding one of the printers connects. Each of the printers accesses the URL assigned by the content server 5 for one of the segments to which each of the printers corresponds, and obtains the template data and the predefined text data necessary for the printing.

As illustrated in FIG. 13A, in the template print mode, the PC 3 generates a print instruction including input text data or a predefined text ID, and a template ID, and transmits the print instruction to the first printer 1. In a case where the first printer 1 is in such a state where printing by the first printer 1 is not completed due to, for example, occurrence of an error, etc., the second printer 2 is capable of performing the substitute printing for the first printer 1. In a case where a USB connection is established between the first printer 1 and the second printer 2 in a state where the first printer 1 and the second printer 2 have transitioned to the substitution mode, the first printer 1 and the second printer 2 are enabled to communicate with each other.

A template DB and a predefined text DB possessed by the first printer 1 and a template DB and a predefined text DB possessed by the second printer 1 might be different in view of the version of each of the databases, in some cases. Alternatively, the second printer 2, initially connected to a segment different from the segment to which the first printer 1 is connected, might be connected to the same segment as the first printer 1, and then the second printer 2 might be connected to the first printer 1 via USB, in some cases. In this case, the kinds of the template DB and the predefined text DB possessed by the first printer 1 differ from the kinds of the template DB and the predefined text DB possessed by the second printer 2.

Therefore, the first printer 1 notifies the second printer 2 of access information with respect to the content server 5 and instructs the second printer 2 to obtain the template data and the predefined text data as the object to be printed. The access information includes segment information of the segment to which the first printer 1 belongs, the URL where data of the content server 5 for the segment is stored, and information such as a login ID, a login password, etc. The second printer 2 transmits an obtainment request to the content server 5, based on the access information. The content server 5 transmits first data, including the template data and the predefined text data as the object to be printed, to the second printer 2. The second printer 2 generates a print image based on the received template data and predefined text data, and prints the print image on a label, thereby performing the substitute printing for the first printer 1.

As illustrated in FIG. 13B, the second printer 2 may receive second data from the content server 5, instead of the first data. Whether the content server 5 transmits either the first data or the second data to the second printer 2 during the substitute printing is preset in the content server 5. Further, whether the first printer 1 transmits the first data or the second data to the second printer 2 during the substitute printing may be set in a substitute application of the first printer 1 or the PC 3. The content server 5 generates a print image based on the template data and the predefined text data as the object to be printed, and transmits the print image to the second printer 2 as the second data. The second printer 2 prints the received print image on a label, thereby performing the substitute printing for the first printer 1.

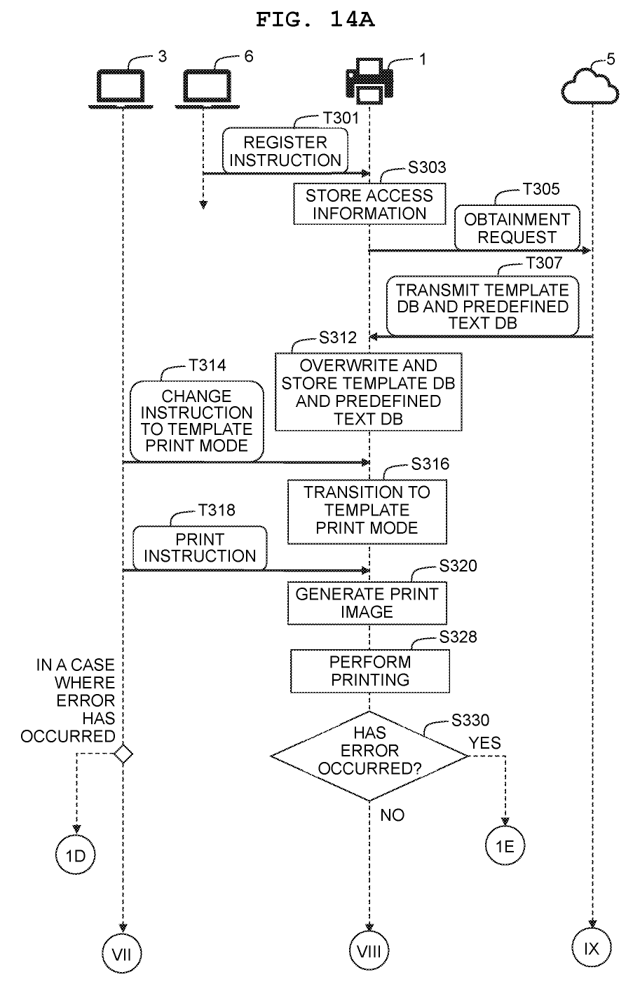

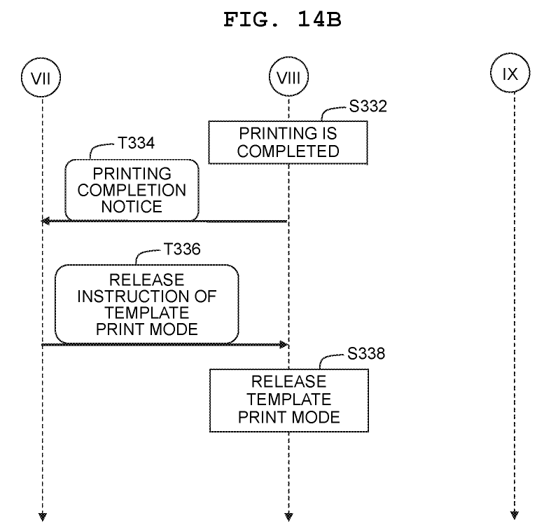

The flow of a process in which the second printer 2 performs the substitute printing for the first printer 1 in the print substitution system 200 of the second embodiment will be described, with reference to sequence diagrams of FIGS. 14A to 20. Note that in the following descriptions of the sequence diagrams, a process performed by the CPU of each of the devices (the PC 3, the printer 1, the printer 2) is described with each of the devices as the subject of the process, rather than describing the CPU of each of the devices as the subject of the process, for the sake of convenience. Further, in the following description of the sequence diagrams, the phrase "via the communication part(s)" in the description of the communication among the devices is omitted, for the sake of convenience.

The first printer 1 is capable of performing printing on a label generated simply using a predefined text and a template. In order to make the predefined text and the template usable, an administrator operates an administrative PC 6 in advance so as to cause the PC 6 to transmit, to the first printer 1, a register instruction to register the first printer 1 with the content server 5 (timing T301). The register instruction includes the access information. The first printer 1 stores the access information received from the PC 6 in the memory 12 (step S303).

The first printer 1 connects to the content server 5 based on the access information, and transmits an obtainment request (timing T305). The obtainment request from the first printer 1 is a download request for the template DB and the predefined text DB corresponding to the segment to which the first printer 1 belongs. The content server 5 registers information on the first printer 1 in the management database. The registered information includes segment information, a printer ID, a status, and a template DB and a predefined text DB corresponding to the segment to which the first printer 1 belongs. The status of the first printer 1 is registered as "operational".

The content server 5 transmits the template DB and the predefined text DB to the first printer 1 (timing T307). The first printer 1 overwrites and stores the received template DB and predefined text DB in the memory 12 (step S312). Each of the template DB and the predefined text DB is updated to the latest version.

The user starts, on the PC 3, an application which is a program for causing the first printer 1 to perform printing, and the user performs an operation to use the first printer 1 in the template print mode. The PC 3 transmits a change instruction to the first printer 1 so that the first printer 1 is changed to the template print mode, in accordance with the operation by the user (timing T314). Upon receiving the change instruction, the first printer 1 transitions to the template print mode in accordance with the change instruction (step S316).

Next, the user operates the PC 3 to generate a print instruction including a predefined text ID or input text data, and a template ID. The PC 3 transmits the generated print instruction to the first printer 1 (timing T318). The first printer 1 receives the print instruction transmitted from the PC 3. The first printer 1 stores, in the memory 12, the template data and either the predefined text data or the input text data based on the print instruction.

The first printer 1 virtually generates, on the memory 12, a print image displaying the predefined text data or the input text data in accordance with a layout defined in the template data (step S320). The first printer 1 prints the generated print image on the label (step S328). In a case where the first printer 1 completes the printing successfully (step S332), without any error occurring during the printing (step S330: NO), the first printer 1 transmits a printing completion notice to the PC 3 (timing T334). Upon receiving the printing completion notice, the PC 3 transmits, to the first printer 1, a release instruction to release the template print mode (timing T336). Upon receiving the release instruction, the first printer 1 releases the template print mode and transitions to the normal print mode (step S338). Note that at least one of timing T334, timing T336, or step S338 may be omitted.

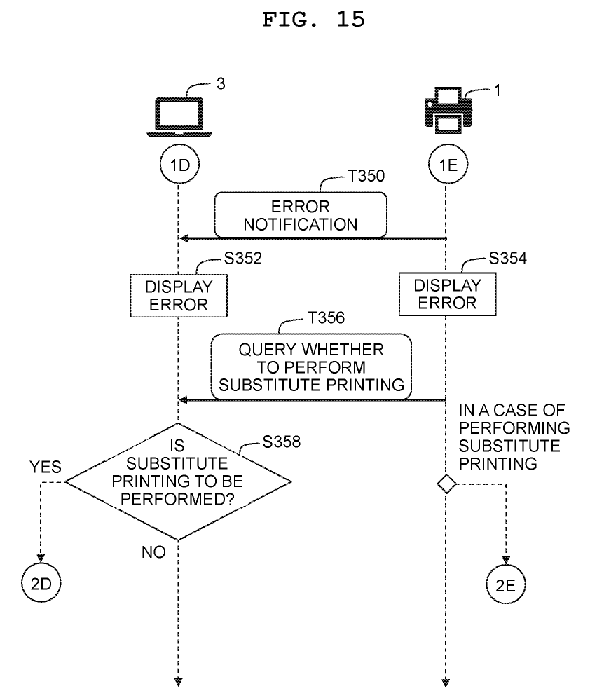

In a case where an error occurs while the first printer 1 is performing the printing on the label (step S330: YES), the printing is not completed. The flows of the processes in the PC 3 and the first printer 1 transition to lifeline 1D and lifeline 1E, respectively. As illustrated in FIG. 15, the first printer 1 transmits, to the PC 3, an error notification to notify the PC 3 that the error has occurred (timing T350). Upon receiving the error notification, the PC 3 displays, in the application, a notice indicating that an error has occurred (step S352). Further, the first printer 1 also causes the display part 14 to display a notice indicating that an error has occurred (step S354). Note that at least one of timing T350, step S352, or step S354 may be omitted.

In a case where the printing by the first printer 1 is not completed due to the error, the first printer 1 queries the PC 3 as to whether to perform the substitute printing (timing T356). In a case where the user operates the operation part 33 to respond to the first printer 1 that the user does not wish to perform the substitute printing (step S358: NO), the PC 3 enters a standby state. In a case where, for example, the error is the first-kind error and where the first-kind error is resolved while the PC 3 is in the standby state, the first printer 1 can print, on the label, the print image stored in the memory 12 and complete the printing.

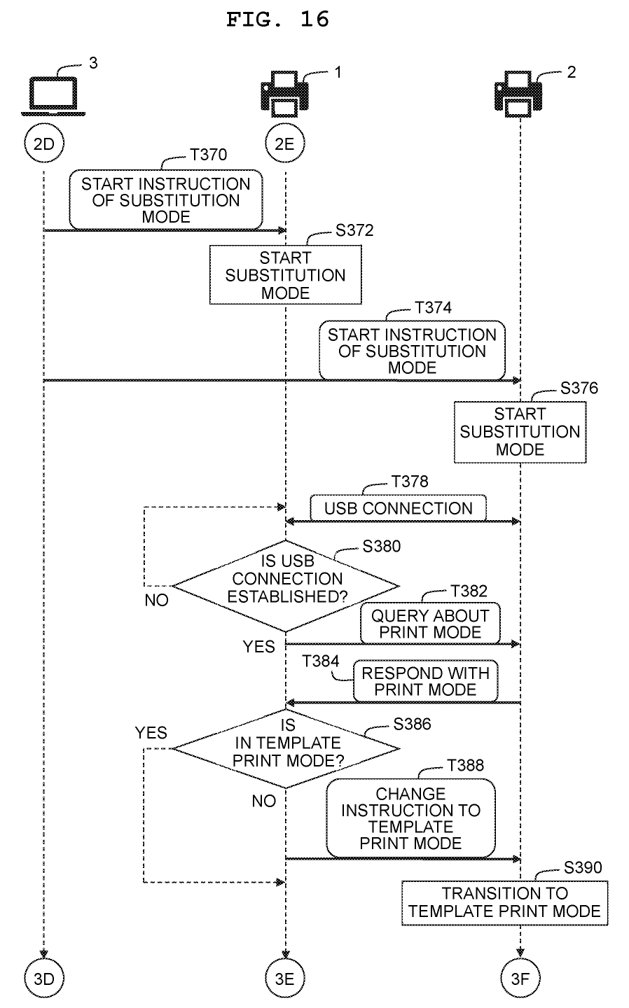

On the other hand, in a case where the user responds to the first printer 1 indicating the user wish to perform the substitute printing (step S358: YES), the flows of the processes in the PC 3 and the first printer 1 shift from the lifeline 1D and the lifeline 1E to lifeline 2D and lifeline 2E, respectively. As illustrated in FIG. 16, the PC 3 transmits a start instruction to start the substitution mode to the first printer 1 and the second printer 2 (timing T370, timing T374). Upon receiving the start instruction, the first printer 1 and the second printer 2 each start the substitution mode (step S372, step S376).

Note that at least one of step S358, timing T370, step S372, timing T374, or step S376 may be omitted. In a case where step S358, timing T370, step S372, timing T374, and step S376 are omitted, the substitution mode may be automatically started by the establishment of the USB connection at timing T378. Further, in a case where step S358, timing T370, and timing T374 are omitted, the first printer 1 and the second printer 2 may accept the instruction to start the substitution mode, in the processes of step S372 and step S376, respectively, in response to the user operating the operation part 13 of the first printer 1.

In a case where the substitution mode is started, the first printer 1 stands by until the second printer 2 is connected to the first printer 1 via USB (step S380: NO). The user uses a USB cable so as to connect the second printer 2 to the first printer 1 via USB (timing T378).

Note that in a case where the user connects the second printer 2 to the first printer 1 via USB, the user may detach the LAN cable from the second printer 2 so as to disconnect the second printer 2 from the network 8. Alternatively, the user may connect the second printer 2 to the first printer 1 via USB, while keeping the second printer 2 connected to the network 8 via the LAN cable. In a case where the user connects the second printer 2 to the network 8 in a state where the LAN cable is detached from the second printer 2, the user may connect the second printer 2 to the network 8 with the first printer 1 as a bridge. Further, the user may use a second printer 2 which is not originally connected to the network 8.

In a case where the second printer 2 is connected to the first printer 1 via USB (step S380: YES), the first printer 1 queries the second printer 2 about the current print mode of the second printer 2 (timing T382). The second printer 2 responds to the first printer 1 with the current print mode of the second printer 2 (timing T384).

In a case where the second printer 2 is already in the template print mode(step S386: YES), the flow of the process in the first printer 1 shifts from the lifeline 2E to lifeline 3E. In a case where the second printer 2 is not in the template print mode(step S386: NO), the first printer 1 transmits, to the second printer 2, a change instruction to change to the template print mode(timing T388). Upon receiving the change instruction, the second printer 2 transitions to the template print mode in accordance with the change instruction (step S390). The flows of the processes in the PC 3 and the first printer 1 transition from the lifeline 2D and the lifeline 2E to lifeline 3D and lifeline 3E, respectively; and the flow of the process in the second printer 2 shifts to lifeline 3F. Note that timing T382, timing T384, and step S386 may be omitted.

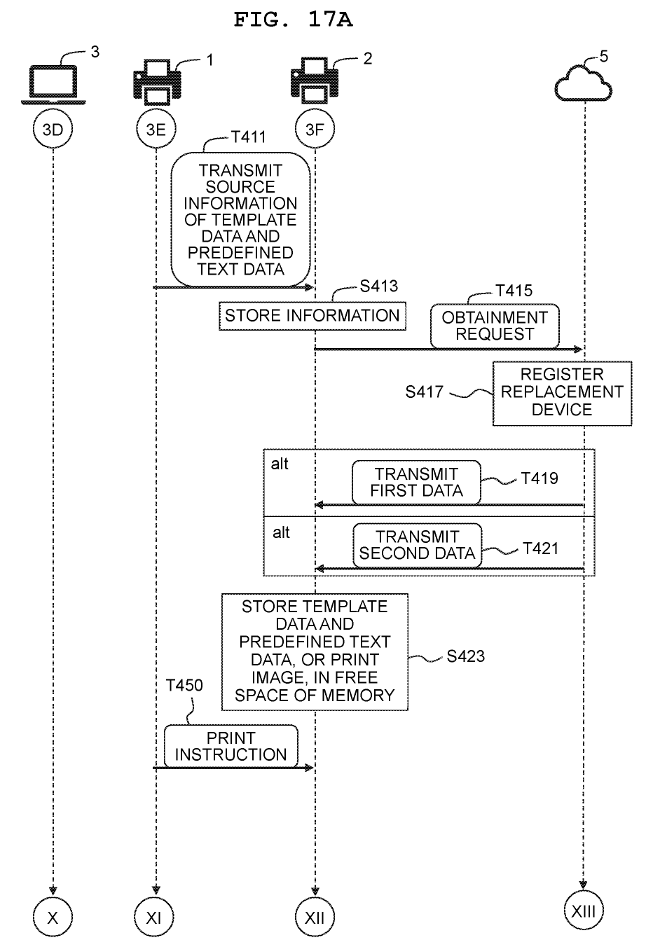

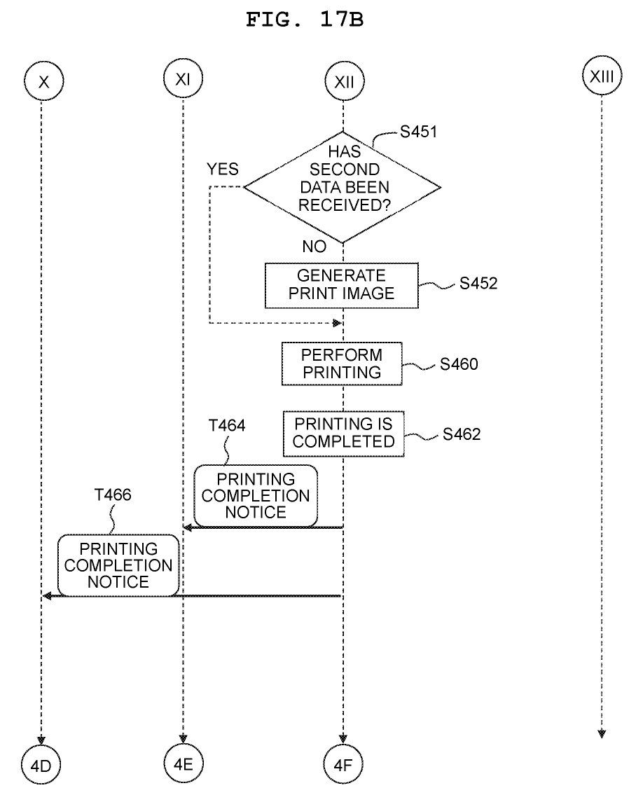

As illustrated in FIGS. 17A and 17B, the first printer 1 transmits, to the second printer 2, information necessary to obtain the template data and the predefined text data from the content server 5 (timing T411). The information necessary to obtain the template data and the predefined text data includes the access information, and the template ID and the predefined text ID included in the print instruction. The second printer 2 stores the information received from the first printer 1 in the memory 22 (step S413). In a case where the print instruction includes the input text data, the second printer 2 stores the input text data in the memory 22.

The second printer 2 connects to the content server 5 based on the access information and transmits an obtainment request (timing T415). The obtainment request transmitted from the second printer 2 is a download request for either the first data which includes the template data and the predefined text data each as the object to be printed, or the second data which includes the print image as the object to be printed. The second printer 2 transmits, to the content server 5, the download request for the first data or the second data, based on the template ID and the predefined text ID received from the first printer 1.

The content server 5 registers the information on the second printer 2 in the management database (step S417). The status of the second printer 2 is set while the second printer 1 is substituting for the first printer 1. The status of the first printer 1 is changed to "out of service".

In a case where a setting for transmitting the first data is enabled (in the content server 5), the content server 5 transmits, to the second printer 2, template data associated with the template ID and predefined text data associated with the predefined text ID as the first data (timing T419). In a case where a setting for transmitting the second data is enabled (in the content server 5), the content server 5 generates a print image in which the predefined text associated with the predefined text ID is applied to a template associated with the template ID. The content server 5 transmits the generated print image as the second data to the second printer 2 (timing T421). The second printer 2 stores the received template data and the predefined text data, or the print image, in a free space of the memory 22 (step S423).

In a case where the second printer 2 receives the first data from the content server 5 (step S451: NO), the second printer 2 generates a print image based on the template data and either the predefined text data or the input text data (step S452). The second printer 2 prints the generated print image on a label (step S460). In a case where the second printer 2 receives the second data from the content server 5 (step S451: YES), the second printer 2 prints the received print image on the label (step S460).

Upon completing printing (step S462), the second printer 2 transmits a printing completion notice to the first printer 1 (timing T464). Further, the second printer 2 transmits the printing completion notice to the PC 3 (timing T466). The flows of the processes in the PC 3, the first printer 1, and the second printer 2 shift from the lifeline 3D, the lifeline 3E and the lifeline 3F to lifeline 4D, lifeline 4E and lifeline 4F, respectively. Note that at least one of step S464 or step S466 may be omitted.

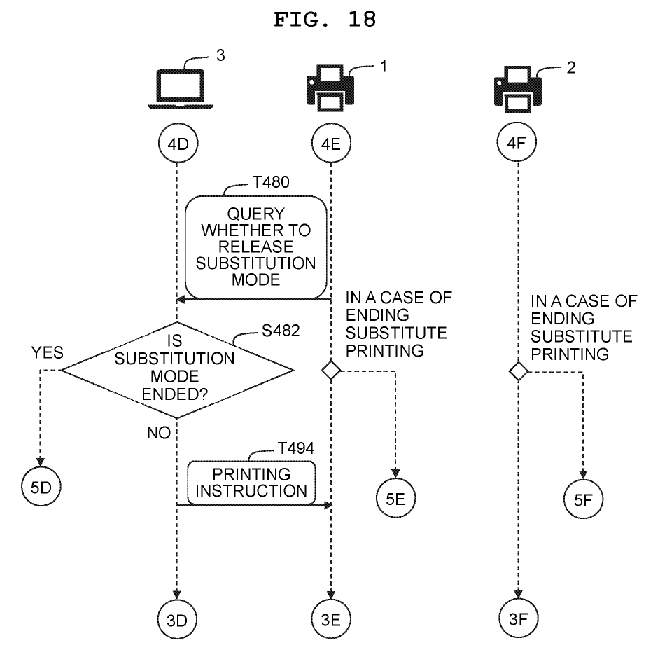

As illustrated in FIG. 18, the first printer 1 queries the PC 3 as to whether to release the substitution mode (timing T480). In a case where the user operates the operation part 33 to respond to the first printer 1 that the user does not wish to release the substitution mode so that the substitute printing is continuously performed (step S482: NO), the PC 3 stands by until the printing is performed on the next label. In a case where a new print instruction is generated in the PC 3, the PC 3 transmits the print instruction to the first printer 1 (timing T494). The flows of the processes in the PC 3, the first printer 1, and the second printer 2 shift from the lifeline 4D, the lifeline 4E and the lifeline 4F to the lifeline 3D, the lifeline 3E and the lifeline 3F, respectively. The second printer 2 receives the first data or the second data from the content server 5, based on the new print instruction, and performs the substitute printing for the first printer 1. Note that timing T480 and step S482 may be omitted. Further, the process of step S482 may be performed by the first printer 1.

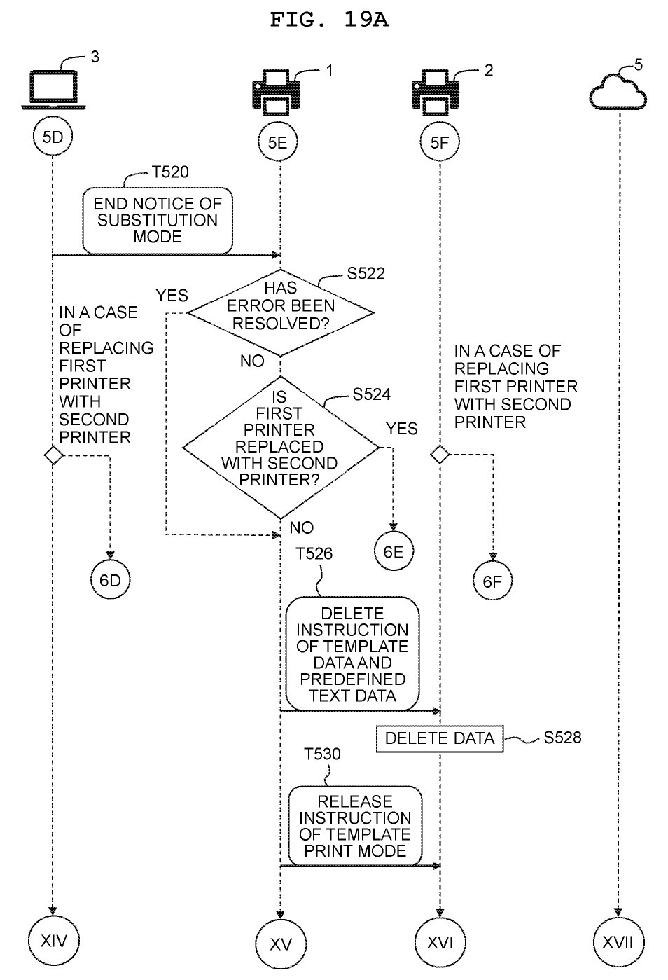

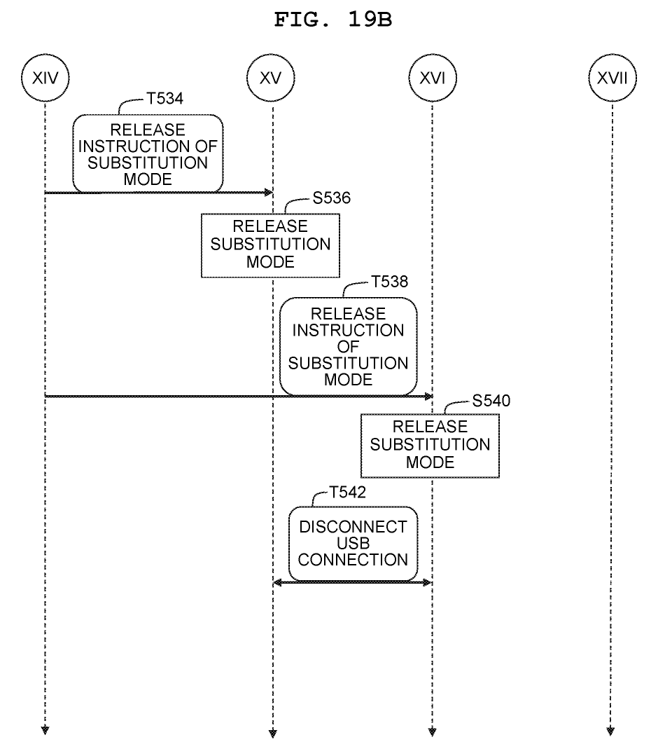

On the other hand, in a case where the user operates the operation part 33 to respond to the first printer 1 in step S482 that the user wishes to release the substitute printing so as to end the substitution mode (step S482: YES), the flows of the processes in the PC 3, the first printer 1, and the second printer 2 shift from the lifeline 4D, the lifeline 4E and the lifeline 4F to lifeline 5D, lifeline 5E and lifeline 5F, respectively. As illustrated in FIGS. 19A and 19B, the PC 3 transmits an end notice for ending the substitution mode to the first printer 1 (timing T520). Note that the process at timing T520 may be omitted.

Upon receiving the end notice for ending the substitution mode, the first printer 1 determines whether the occurred error has been resolved (step S522). In a case where the first printer 1 determines that the error has not been resolved (step S522: NO), the first printer 1 accepts(, from the PC 3,) a response regarding whether to replace the first printer 1 with the second printer 2 and to cause the second printer to perform the printing (step S524). The first printer 1 causes the display part 14 to display a screen to accept a response regarding whether the first printer 1 is to be replaced with the second printer 2 as the replacement device, and the first printer 1 accepts a response from the user, via the operation of the operation part 13 by the user. Note that at least one of step S522 or step S524 may be omitted.

In a case where the first printer 1 determines that the error is resolved (step S522: YES), or in a case where the user operates the operation part 13 to respond to the first printer 1 that the user does not wish to replace the first printer 1 with the second printer 2 as the replacement device (step S524: NO), the first printer 1 transmits a delete instruction to the second printer 2. Namely, the first printer 1 transmits, to the second printer 2, a delete instruction to delete the template data and the predefined text data stored in the memory 22 in the substitute printing (timing T526). The second printer 2 deletes the template data and the predefined text data stored in the memory 22 (step S528). Note that at least one of timing T526 or step S528 may be omitted.

The first printer 1 transmits the release instruction to release the template print mode to the second printer 2 (timing T530). Upon receiving the release instruction, the second printer 2 releases the template print mode and transitions to the normal print mode (step S532). Note that at least one of timing T530 or step S532 may be omitted.

The PC 3 transmits a release instruction to release the substitution mode to the first printer 1 and the second printer 2 (timing T534, step S538). Upon receiving the release instruction, each of the first printer 1 and the second printer 2 releases the substitution mode (step S536, step S540). The user detaches the USB cable connecting the first printer 1 and the second printer 2 so as to disconnect the USB connection (timing T542). In this manner, in a case where the substitution mode is released, without replacing the first printer 1 with the second printer 2 as the replacement device, the second printer 2 deletes the template data and the predefined text data received from the content server 5. Note that at least one of timing T534 or timing T538 may be omitted. In this case, each of the first printer 1 and the second printer 2 may detect the disconnection of the USB connection at timing T542, and the first printer 1 may perform the process of step S536 and the second printer 2 may perform the process of step S540.

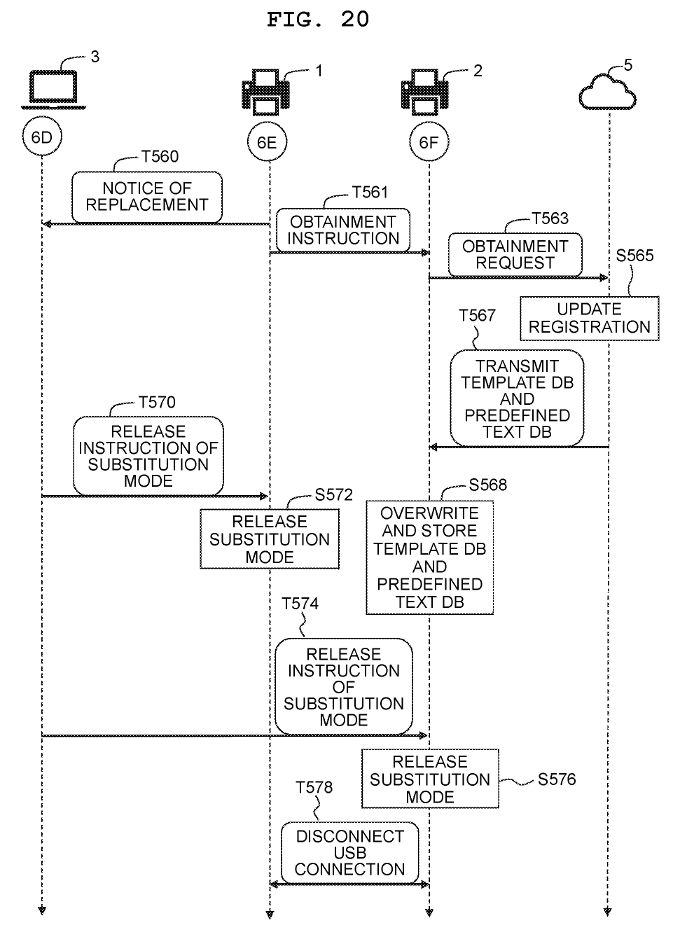

Next, in a case where the substitution mode is released and where the user operates the operation part 13 to respond to the first printer 1 that the user wishes to replace the first printer 1 with the second printer 2 as the replacement device (step S524: YES), the flows of the processes in the PC 3, the first printer 1, and the second printer 2 shift from the lifeline 5D, the lifeline 5E and the lifeline 5F to lifeline 6D, lifeline 6E and lifeline 6F, respectively. As illustrated in FIG. 20, the first printer 1 transmits a notice to the PC 3 indicating that the first printer 1 is to be replaced with the second printer 2 as the replacement device (timing T560).

The first printer 1 transmits, to the second printer 2, an instruction to obtain the template DB and the predefined text DB (step S561). The second printer 2 connects to the content server 5 based on the access information, and transmits an obtainment request to the content server 5 (timing T563). The obtainment request from the second printer 2 is a download request for the template DB and the predefined text DB corresponding to the segment to which the second printer 2 belongs. The status of the second printer 2 is updated to "operational" (step S565). Further, the content server 5 deletes the information on the first printer 1 from the management database.

The content server 5 transmits the template DB and the predefined text DB to the second printer 2 (timing T567). The second printer 2 overwrites and stores the template DB and the predefined text DB received from the content server 5, in the memory 22 (step S568). The second printer 2 consequently has the template DB and the predefined text DB which are the same as the template DB and the predefined text DB possessed by the first printer 1. The template DB and the predefined text DB possessed by the second printer 2 include a template ID and a predefined text ID which are different from the template ID and the predefined text ID corresponding to the print instruction at timing T318.

The PC 3 transmits a release instruction to release the substitution mode to the first printer 1 and the second printer 2 (timing T570, timing T574). Upon receiving the releasing instruction, each of the first printer 1 and the second printer 2 releases the substitution mode (step S572, step S576). Thus, in a case where the first printer 1 is replaced with the second printer as the replacement device, the second printer 2 consequently has the template DB and the predefined text DB which are the same as the template DB and the predefined text ID possessed by the first printer 1. The user detaches the USB cable connecting the first printer 1 and the second printer 2, thereby disconnecting the USB connection (timing T578). The PC 3 transmits the print instruction to the second printer 2 which is connected to the first printer 1 via the network 8. The second printer 2 is capable of performing printing on a label, as the replacement device for the first printer 1.

Note that the timing T560 may be omitted. Further, at least one of timing T570 or timing T574 may be omitted. In this case, each of the first printer 1 and the second printer 2 may detect the disconnection of the USB connection at timing T578, and the first printer 1 may perform the process of step S572 and the second printer 2 may perform the process of step S576.

As described above, the second printer 2 receives the first data, which includes the predefined text data and the template data, from the content server 5. Alternatively, the second printer 2 receives, from the content server 5, the second data which indicates the print image based on the predefined text data and the template data. Therefore, even in a case where the second printer 2 does not possess the template data, the second printer 2 is capable of printing, on a label, an appropriate print image based on the first data or the second data. Thus, the second printer 2 contributes to printing an appropriate print image based on the print instruction on the label, as the substitute for the first printer 1.

In the second embodiment, the process in which the second printer 2 receives the access information (timing T411) is an example of a "second receiving process" of the present disclosure. The process in which the second printer 2 receives the first data (timing T419), or the process in which the second printer 2 receives the second data (timing T421), is an example of a "third receiving process" of the present disclosure. The process in which the second printer 2 performs the printing (step S460) is an example of a "third printing process" of the present disclosure.

The present disclosure is not limited to the second embodiment, and various modifications are possible. The above-described modifications of the first embodiment are also applicable to the second embodiment. Further, in the second embodiment, the kinds of the template DB and the predefined text DB are different depending on the segments in the network 8. However, the present disclosure is not limited to this feature regarding the segments. For example, the printers may include identifiers, respectively, and the kinds of the database may differ depending on the identifiers.

The content server 5 may be a server which simply provides the template data and the predefined text data, rather than managing the operational status of the printer. In a case where the first printer 1 is to be replaced by the second printer 2, the content server 5 deletes the information on the first printer 1 from the management database. However, the content server 5 may retain the information on the first printer 1 as being "out of service". Alternatively, upon deleting the information on the first printer 1, the content server 5 may rewrite the printer ID of the second printer 2 over the printer ID of the first printer 1 so that the user is capable of using the second printer 2 as the first printer 1.

What is claimed is:

1. A printing apparatus, comprising:
a first memory storing a template database including one or more records, each of the one or more records including a template ID and template data, the template data being used to print a predetermined print content based on a predetermined layout, the template ID being associated with the template data;
a printing mechanism;
a communication interface; and
a processor configured to cause the printing apparatus to perform:
an obtaining process of obtaining a print instruction including related information related to print content data which indicates the print content, and the template ID;
a first printing process of causing the printing mechanism to perform printing of a print image in which the print content, identified based on the related information, is applied to the layout indicated by the template data associated with the template ID, in a case where the processor obtains the print instruction in the obtaining process; and
a first transmitting process of transmitting first data or second data to another printing apparatus via the communication interface, in a case where the printing by the first printing process is not completed and where the another printing apparatus is connected to the printing apparatus, the first data including the print content data related to the related information and the template data associated with the template ID, the second data indicating the print image based on the print content data and the template data.

2. The printing apparatus according to claim 1, wherein after the first transmitting process, the processor is configured to perform a second transmitting process of transmitting the template database to the another printing apparatus via the communication interface.

3. The printing apparatus according to claim 1, wherein
the first memory stores a print content database including one or more records, each of the one or more records including identification information and the print content data corresponding to the print content, the identification information being associated with and identifying the print content data,
the related information is the identification information, and
in the first transmitting process, the processor is configured to transmit, to the another printing apparatus via the communication interface, the first data including the print content data identified from the print content database based on the identification information, and the template data associated with the template ID, or the second data indicating the print image in which the print content indicated by the print content data identified from the print content database based on the identification information is applied to the layout indicated by the template data associated with the template ID.

4. The printing apparatus according to claim 3, wherein after the first transmitting process, the processor is configured to perform a third transmitting process of transmitting the print content database to the another printing apparatus via the communication interface.

5. The printing apparatus according to claim 3, wherein in a case where the another printing apparatus does not possess the print content data associated with the identification information,
in the first transmitting process:
the processor is configured to transmit the first data and the print content database to the another printing apparatus via the communication interface, in a case where a first condition is satisfied, the first condition being condition that a file size of the print content database is smaller than a predetermined size, and
the processor is configured to transmit the first data or the second data to the another printing apparatus via the communication interface, in a case where the first condition is not satisfied.

6. The printing apparatus according to claim 3, wherein in a case where the another printing apparatus does not possess the print content data associated with the identification information,
in the first transmitting process:
the processor is configured to transmit the first data and the print content database to the another printing apparatus via the communication interface, in a case where a second condition is satisfied, the second being a condition that a number of the print content data included in the print content database is greater than a predetermined number; and
the processor is configured to transmit the first data or the second data to the another printing apparatus via the communication interface, in a case where the second condition is not satisfied.

7. The printing apparatus according to claim 3, wherein
in a case where the printing by the first printing process is not completed, the printing apparatus has a predetermined first-kind error or a predetermined second-kind error which takes a longer time to be resolved than the first-kind error,
in a case where the another printing apparatus does not possess the print content data associated with the identification information,
in the first transmitting process,
the processor is configured to transmit the first data and the print content database to the another printing apparatus via the communication interface, in a case where a third condition is satisfied, the third condition being a condition that the printing apparatus has the second-kind error; and
the processor is configured to transmit the first data or the second data to the another printing apparatus via the communication interface, in a case where the third condition is not satisfied.

8. The printing apparatus according to claim 1, wherein
the related information is the print content data, and
the processor is configured to obtain the print instruction including the print content data in the obtaining process.

9. The printing apparatus according to claim 2, wherein
after the first transmitting process, the processor is configured to perform an accepting process of accepting a response to a query as to whether the printing apparatus is to be substituted with another printing apparatus, and
in a case where the processor accepts a response indicating that the printing apparatus is to be substituted with the another printing apparatus in the accepting process, the processor is configured to transmit the template database to the another printing apparatus via the communication interface, in the second transmitting process.

10. The printing apparatus according to claim 4, wherein
after the first transmitting process, the processor is configured to perform an accepting process of accepting a response to a query as to whetherthe printing apparatus is to be substituted with the another printing apparatus, and
in a case where the processor accepts a response indicating that the printing apparatus is to be substituted with the another printing apparatus in the accepting process, the processor is configured to transmit the print content database to the another printing apparatus via the communication interface, in the third transmitting process.

11. The printing apparatus according to claim 9, wherein
in a case where the printing by the first printing process is not completed, the printing apparatus has a predetermined first-kind error or a predetermined second-kind error which takes a longer time to be resolved than the first-kind error,
in a case where the printing apparatus has the first-kind error, the processor is configured not to perform the accepting process, and
in a case where the printing apparatus has the second-kind error, the processor is configured to perform the accepting process.

12. The printing apparatus according to claim 1, wherein
the communication interface includes a connection interface through which the another printing apparatus is peer-to-peer connected to the printing apparatus, and
in the first transmitting process, in a case where the connection interface identifies that the another printing apparatus is connected to the printing apparatus, the processor is configured to determine that the another printing apparatus is connected to the printing apparatus.

13. The printing apparatus according to claim 1, further comprising an internal clock,
wherein the processor is configured to perform:
a date-and-time obtaining process of obtaining date-and-time information from the internal clock; and
a first querying process of querying the another printing apparatus as to whether the another printing apparatus has the internal clock, via the communication interface, and
in a case where a result of the first querying process is that the another printing apparatus does not have the internal clock, in the first transmitting process, the processor is configured to transmit the first data including the date-and-time information, or the second data in which a date-and-time image based on the date-and-time information is added to the print image, to the another printing apparatus via the communication interface.

14. The printing apparatus according to claim 1, wherein
the another printing apparatus further includes a memory,
the another printing apparatus has a template print mode in which the print image is printed using the template data stored in the memory of the another printing apparatus,
in a case where the another printing apparatus is connected to the printing apparatus, the processor is configured to perform a second querying process of querying the another printing apparatus as to whether the another printing apparatus is in the template print mode, via the communication interface, and
in a case where a result of the second querying process is that the another printing apparatus is not in the template print mode, the processor is configured to perform a mode transition process of transmitting an instruction to transition to the template print mode, to the another printing apparatus.

15. The printing apparatus according to claim 14, wherein
the processor is configured to perform an accepting process of accepting a response to a query as to whether the printing apparatus is to be substituted with another printing apparatus, and
after the mode transition process, in a case where the processor accepts a response indicating that the printing apparatus is not to be substituted with the another printing apparatus in the accepting process, the processor is configured to perform a transition canceling process of transmitting an instruction to cancel the transition to the template print mode, to the another printing apparatus.

16. A printing apparatus configured to substitute for another printing apparatus so as to perform printing in a case where printing by the another printing apparatus is not completed, the printing apparatus comprising:
a communication interface;
a printing mechanism; and
a processor configured to cause the printing apparatus to perform:
a first receiving process of receiving first data or second data from the another printing apparatus via the communication interface, the first data including print content data indicating a predetermined print content and template data used to print the print content based on a predetermined layout, the second data indicating a print image in which the print content is applied to the layout; and
a second printing process of causing the printing mechanism to perform printing based on the first data or the second data, in a case where the processor receives the first data or the second data in the first receiving process.

17. The printing apparatus according to claim 16, further comprising a second memory,
wherein the another printing apparatus has: a template database including one or more records, each of the one or more records including a template ID and the template data, the template ID being associated with the template data; and a print content database including one or more records, each of the one or more records including identification information and the print content data, the identification information being associated with the print content data; and
in a case where the printing apparatus is used as a substitution of the another printing apparatus, and where the processor receives the template database and the print content database from the another printing apparatus in the first receiving process, the processor is configured to perform a storing process of causing the second memory to store the template database and the print content database.

18. The printing apparatus according to claim 16, wherein in the second printing process, in a case where the processor receives the first data including date-and-time information, or the second data including a date-and-time image based on the date-and-time information, the processor is configured to cause the printing mechanism to perform printing in which the print content and the date-and-time information is applied to the layout indicated by the template data, or to perform printing of the print image to which the date-and-time image is added.

19. A printing apparatus configured to substitute for another printing apparatus so as to perform printing in a case where printing by the another printing apparatus is not completed, the printing apparatus comprising:
a communication interface;
a printing mechanism; and
a processor configured to cause the printing apparatus to perform:
a second receiving process of receiving access information to a content server, from the another printing apparatus via the communication interface;
a third receiving process of receiving first data or second data from the content server by using the access information, the first data including: related information related to print content data indicating a predetermined print content; and template data being used to print the print content based on a predetermined layout, the second data indicating a print image in which the print content is applied to the layout; and
a third printing process of causing the printing mechanism to perform printing based on the first data or the second data, in a case where the processor receives the first data or the second data in the third receiving process.
